(19) United States
(12) Patent Application Publication
(10) Pub. No.: US 2004/0259551 A1
(43) Pub. Date: Dec. 23, 2004

(54) Information communication system, information communication apparatus and method, and program

(75) Inventors: Shoko Ihori, Tokyo (JP); Sei Kono, Tokyo (JP); Ko Togashi, Tokyo (JP); Toru Ino, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, TOKYO (JP)

(21) Appl. No.: 10/815,872

(22) Filed: Apr. 2, 2004

(30) Foreign Application Priority Data
Apr. 11, 2003 (JP) 2003-108276

(51) Int. Cl. H04Q 7/20

(52) U.S. Cl. 455/445; 455/422.1

(57) ABSTRACT

An information communication system and apparatus is disclosed wherein setting necessary for communication with a desired information communication apparatus with which a user wants to communicate can be performed with certainty by an operation system familiar to the user and a high security level can be assured for the communication which uses the setting. A first radio communication apparatus in which communication information necessary for communication through a radio network is set in advance is connected to a second communication apparatus through a wire circuit, an information repeating apparatus and another wire circuit. When setting switches of the first and second radio communication apparatus are depressed individually, the first radio communication apparatus transmits the communication information to the second radio communication apparatus by wire communication. The second radio communication apparatus sets the communication information to itself. The invention can be applied to a radio LAN for which an appliance is used.

### BACKGROUND OF THE INVENTION

This invention relates to an information communication system, an information communication apparatus and method and a program.

In recent years, a radio LAN (Local Area Network) which utilizes the radio communication standards of the IEEE (The Institute of Electrical and Electronic Engineers, Inc.) 802.11a, 802.11b or 802.11g has been popularized. An example of a radio LAN of the type mentioned is disclosed, for example, in Japanese Patent Laid-Open No. 2002-359623 (hereinafter referred to as Patent Document 1).

Conventionally, however, in order to construct such a radio LAN as described above, it is necessary for a user to set unique information such as identification information of the radio LAN such as, for example, an SSID (Service Set Identification) or information regarding the security such as, for example, a WEP (Wired Equivalent Privacy) key using software for exclusive use installed suitably in a personal computer (hereinafter referred to suitably as PC (Personal Computer)).

It is to be noted that, although the software for exclusive use sometimes is a setting tool itself, since such setting is generally performed through setting of a W.W.W. (World Wide Web) page provided in the inside of an access point, in such an instance, a W.W.W. browser corresponds to the software for exclusive use. Or, also a W.W.W. browser may be regarded as one of setting tools.

Thus, there is a first subject in that, in order to construct a ratio LAN, it is necessary for a user to perform complicated operations including a plurality of manual operations such as, for example, manual inputting of an SSID and long operating time is required for the operations.

Further, most setting tools are application software for a PC. Therefore, there is a second subject that a user that does not have a PC cannot construct a radio LAN. In recent years, not only a PC but also a household electric appliance such as a hard disk recorder is available as a terminal of a radio LAN, and the second subject described is remarkable trend particularly to a user who desires to construct a radio LAN using a household electric appliance without using a PC.

In order to solve the first and second subjects described above, a method has been proposed wherein a station such as, for example, a PC card or a converter for a radio LAN to which information of an access point such as, for example, an SSID is set in advance is sold in a set together with an access point. The method, however, does not solve the first and second subjects sufficiently because the first and second subjects take place where the setting of the access point is changed or another station is purchased newly.

In order to solve the first and second subjects, for example, Patent Document 1 discloses a method wherein two radio communication apparatuses between which radio communication is to be performed are connected to each other by a wire and setting of radio communication is started using the connection by a wire circuit as a trigger.

However, according to the method disclosed in Patent Document 1, setting of radio communication is started immediately at a point of time when two radio communication apparatuses are connected to each other by a wire circuit. As a result, a new subject, that is, a third subject, takes place that, in the radio communication for which such setting has been performed, the safety in communication cannot be assured.

In particular, for example, where an access point which is a radio communication apparatus is connected already to a hub, only if a user connects a terminal, that is, a radio communication apparatus, owned thereby to the hub, or in other words, while the user does not confirm what that access point is or while the user does not know that the access point is connected to the hub, setting of radio communication is started. Therefore, the safety in communication cannot be assured in the radio communication with the access point set in this manner.

Furthermore, where a plurality of access points are connected to a hub, if a user connects a terminal owned thereby to the hub, then a connection is established between the terminal and a predetermined one of the plural access points which cannot be specified by the user. Therefore, a fourth subject takes place that setting of radio communication with an access point with which the user wants to communicate cannot always be performed.

### SUMMARY OF THE INVENTION

It is an object of the present invention to provide an information communication system, an information communication apparatus and method and a program wherein setting necessary for communication with a desired information communication apparatus with which a user desires to communicate can be performed with certainty by an operation system familiar to the user and a high security level can be assured for the communication which uses the setting.

In order to attain the object described above, according to an aspect of the present invention, there is provided a first information communication system, including two or more information communication apparatuses connected to each other by a network and including first and second information communication apparatuses, the first information communication apparatus having communication information necessary for communication through the network set therein in advance, the first information communication apparatus being connected to the second information communication apparatus by a wire circuit, the first and second information apparatuses being operable, when a predetermined signal based on an operation of a user is inputted individually to the first and second information apparatuses, such that the first information communication apparatus transmits the communication information to the second information communication apparatus through the wire circuit and the second information communication apparatus sets the communication information transmitted thereto from the first information communication apparatus, whereafter the first and second information communication apparatuses utilize the communication information set therein to perform communication therebetween.

According to another aspect of the present invention, there is provided an information communication method for a first information communication system wherein two or more information communication apparatuses including first and second information communication apparatus are connected to each other by a network, the first information communication apparatus having communication information necessary for communication through the network set therein in advance, the first information communication apparatus being connected to the second information communication apparatus by a wire circuit, the information communication method being performed when a predetermined signal based on an operation of a user is inputted individually to the first and second information apparatuses, the information communication method including a step performed by the first information communication apparatus of transmitting the communication information to the second information communication apparatus through the wire circuit, another step performed by the second information communication apparatus of setting the communication information transmitted thereto from the first information communication apparatus, and a further step performed by the first and second information communication apparatuses of utilizing the communication information set therein to perform communication therebetween.

In the first information communication system and method, a first information communication apparatus in which communication information necessary for communication through a network is set in advance and a second information communication apparatus are connected to each other by a wire circuit. If a predetermined signal based on an operation of the user is inputted to the first and second information communication apparatuses, then the communication information is transmitted from the first information communication apparatus to the second information communication apparatus through the wire circuit. Then, the second information communication apparatus sets the communication information in the second information communication apparatus itself. Thereafter, communication which utilizes the set communication information is performed by and between the first and second information communication apparatuses.

The first information communication system may be any system only if at least two information communication apparatuses therein communicate with each other through a network. In other words, the form of the network is not limited particularly and may be a wire network or a radio network.

Further, in the present specification, also where two information communication apparatuses communicate directly with each other, it is interpreted that a network is constructed between the two information communication apparatuses. In particular, in the present specification, the term “network” is any communication form which includes at least two information communication apparatuses.

Accordingly, each of the information communication apparatus which construct the first information communication system may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the first information communication system may involve radio communication used in a certain interval and wire information used in another certain interval.

According to a further aspect of the present invention, there is provided a first information communication apparatus which communicates with a different information communication apparatus connected to a network through the network, including connection means for establishing a connection to the different information communication apparatus through a wire circuit, input means for inputting a trigger signal to start setting necessary for the information communication apparatus to communicate with the different information communication apparatus through the network, and transmission control means for controlling, when a request for transmission of communication information necessary for communication through the network is received from the different information communication apparatus connected to the connection means through the wire circuit after the trigger signal is inputted from the input means, transmission of the communication information set in advance in the information communication apparatus to the different information communication apparatus through the connection means and the wire circuit.

According to a still further aspect of the present invention, there is provided an information communication method for a first information communication apparatus which communicates with a different information communication apparatus connected to a network through the network, including a transmission control step of controlling, when a request for transmission of communication information necessary for communication through the network is received from the different information communication apparatus connected to the first information communication apparatus through a wire circuit after a trigger signal for starting setting necessary for performing communication with the different information communication apparatus through the network is inputted, transmission of the communication information set in advance in the information communication apparatus to the different information communication apparatus through the wire circuit.

According to a yet further aspect of the present invention, there is provided a first program for causing a computer, which controls an information communication apparatus which communicates with a different information communication apparatus connected to a network through the network, to execute a transmission control step of controlling, when a request for transmission of communication information necessary for communication through the network is received from the different information communication apparatus connected to the information communication apparatus through a wire circuit after a trigger signal for starting setting necessary for performing communication with the different information communication apparatus through the network is inputted, transmission of the communication information set in advance in the information communication apparatus to the different information communication apparatus through the wire circuit.

In the first information communication apparatus and method and the first program, when a request for transmission of communication information necessary for communication through a network is received from a different information communication apparatus connected to the first information communication apparatus through a wire circuit after a trigger signal for starting setting necessary for performing communication with the different information communication apparatus through the network is inputted, the communication information set in advance in the first information communication apparatus is transmitted to the different information communication apparatus through the wire circuit.

The first information communication apparatus may be any information communication apparatus which communicates with the different information communication apparatus through the network.

Accordingly, the first information communication apparatus may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the first information communication system may involve radio communication used in a certain interval and wire information used in another certain interval.

According to an additional aspect of the present invention, there is provided an information communication apparatus which communicates with a different information communication apparatus connected to a network through the network, including connection means for establishing a connection to the different information communication apparatus through a wire circuit, input means for inputting a trigger signal to start setting necessary for the information communication apparatus to communicate with the different information communication apparatus through the network, transmission control means for controlling, after the trigger signal is inputted from the input means, transmission of request information for requesting for communication information necessary for communication through the network to the different information communication apparatus through the connection means and the wire circuit, reception control means for controlling, when the communication information is transmitted from the different information apparatus to the information communication apparatus through the wire circuit in response to the request information transmitted under the control of the transmission control means, reception of the communication information through the connection means, and setting means for setting the communication information received under the control of the reception control means.

According to another additional aspect of the present invention, there is provided an information communication method for a second information communication apparatus which communicates with a different information communication apparatus connected to a network through the network, including a transmission control step of controlling, after the trigger signal for starting setting necessary to communicate with the different information communication apparatus through the network is inputted to the second information communication apparatus, transmission of request information for requesting for communication information necessary for communication through the network to the different information communication apparatus through the wire circuit, a reception control step of controlling, when the communication information is transmitted from the different information apparatus to the second information communication apparatus through the wire circuit in response to the request information transmitted under the control of the process at the transmission control step, reception of the communication information by the information communication apparatus, and a setting step of setting the communication information received under the control of the process at the reception control step to the second information communication apparatus.

According to a further additional aspect of the present invention, there is provided a second program for causing a computer, which controls an information communication apparatus which communicates with a different information communication apparatus connected to a network through the network, to execute a transmission control step of controlling, after the trigger signal for starting setting necessary to communicate with the different information communication apparatus through the network is inputted to the second information communication apparatus, transmission of request information for requesting for communication information necessary for communication through the network to the different information communication apparatus through the wire circuit, a reception control step of controlling, when the communication information is transmitted from the different information apparatus to the information communication apparatus through the wire circuit in response to the request information transmitted under the control of the process at the transmission control step, reception of the communication information by the information communication apparatus, and a setting step of setting the communication information received under the control of the process at the reception control step to the information communication apparatus.

In the second information communication apparatus and method and the second program, after a trigger signal for starting setting necessary for performing communication with a different information communication apparatus through a network is inputted, request information for requesting for transmission of communication information necessary for communication through the network is transmitted from the different information communication apparatus to the second information communication apparatus through the wire circuit. Then, the communication information corresponding to the request information is transmitted from the different information communication apparatus to the second information communication apparatus through the wire circuit. Thereafter, the communication information is set to the second information communication apparatus.

The second information communication apparatus may be any information communication apparatus which communicates with the different information communication apparatus through the network.

Accordingly, the second information communication apparatus may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the first information communication apparatus may involve radio communication used in a certain interval and wire information used in another certain interval.

According to a still further additional aspect of the present invention, there is provided a second information communication system, including two or more information communication apparatuses connected to each other by a network and including first and second information communication apparatus, the first information communication apparatus having communication information necessary for communication through the network set therein in advance, the first information communication apparatus transmitting, when a request for transmission of the communication information is received from the second information communication apparatus through a wire circuit before a predetermined first period of time elapses after the first information communication apparatus starts setting for performing communication with the second information communication apparatus through the network, the communication information to the second information communication apparatus through the wire circuit, the second information communication apparatus setting, when the communication information for which the second information communication apparatus has requested to the first information communication apparatus through the wire circuit is transmitted to the second information communication apparatus from the first information communication apparatus through the wire circuit before a predetermined second period of time elapses after setting for performing communication with the first information communication apparatus through the network is started, the communication information transmitted thereto from the first information communication apparatus, the first and second communication apparatus thereafter utilizing the communication information set therein to perform communication therebetween.

According to a yet further additional aspect of the present invention, there is provided an information communication method for a second information communication system wherein two or more information communication apparatuses including first and second information communication apparatus are connected to each other by a network and the first information communication apparatus has communication information necessary for communication through the network set therein in advance, including a step performed by the first information communication apparatus of transmitting, when a request for transmission of the communication information is received from the second information communication apparatus through a wire circuit before a predetermined first period of time elapses after the first information communication apparatus starts setting for performing communication with the second information communication apparatus through the network, the communication information to the second information communication apparatus through the wire circuit, another step performed by the second information communication apparatus of setting, when the communication information for which the second information communication apparatus has requested to the first information communication apparatus through the wire circuit is transmitted to the second information communication apparatus from the first information communication apparatus through the wire circuit before a predetermined second period of time elapses after setting for performing communication with the first information communication apparatus through the network is started, the communication information transmitted thereto from the first information communication apparatus, and a further step performed by the first and second communication apparatus of utilizing the communication information set therein to perform communication therebetween.

In the information communication system and method, when a first information communication apparatus in which communication information necessary for communication through a network is set in advance receives a request for transmission of the communication information from a second information communication apparatus through a wire circuit before a predetermined first period of time elapses after the first information communication apparatus starts setting for performing communication with the second information communication apparatus, the communication information corresponding to the request is transmitted to the second information communication apparatus through the wire circuit from the first information communication apparatus. Then, when the communication information for which the second information communication apparatus has requested to the first information communication apparatus through the wire circuit is transmitted to the second information communication apparatus from the first information communication apparatus through the wire circuit before a predetermined second period of time elapses after setting for performing communication with the first information communication apparatus through the network is started, the communication information is set to the second information communication apparatus. Thereafter, the first and second communication apparatus utilize the communication information individually set therein to perform communication therebetween.

The second information communication system may be any system only if at least two information communication apparatus therein communicate with each other through a network. In other words, the form of the network is not limited particularly and may be a wire network or a radio network.

Accordingly, each of the information communication apparatus which construct the second information communication system may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the information communication system may involve radio communication used in a certain interval and wire information used in another certain interval.

According to a yet further aspect of the present invention, there is provided a third information communication apparatus which communicates with a different information communication apparatus connected to a network through the network, including connection means for establishing a connection to the different information communication apparatus through a wire circuit, and transmission control means for controlling, when a request for transmission of communication information necessary for communication through the network is received from the different information communication apparatus connected to the connection means through the wire circuit before a predetermined period of time elapses after setting for performing communication with the different information communication apparatus through the network is started, transmission of the communication information set in advance in the information communication apparatus to the different information communication apparatus through the connection means and the wire circuit.

According to a yet further aspect of the present invention, there is provided an information communication method for a third information communication apparatus which communicates with a different information communication apparatus connected to a network through the network, including a transmission control step of controlling, when a request for transmission of communication information necessary for communication through the network is received from the different information communication apparatus connected to the information communication apparatus through the wire circuit before a predetermined period of time elapses after setting for performing communication with the different information communication apparatus through the network is started, transmission of the communication information set in advance in the information communication apparatus to the different information communication apparatus through the wire circuit.

According to a yet further aspect of the present invention, there is provided a third program for causing a computer, which controls an information communication apparatus which communicates with a different information communication apparatus connected to a network through the network, to execute a transmission control step of controlling, when a request for transmission of communication information necessary for communication through the network is received from the different information communication apparatus connected to the information communication apparatus through the wire circuit before a predetermined period of time elapses after setting for performing communication with the different information communication apparatus through the network is started, transmission of the communication information set in advance in the information communication apparatus to the different information communication apparatus through the wire circuit.

In the third information communication apparatus and method and the program, when a request for transmission of communication information necessary for communication through a network is received from a different information communication apparatus connected to the information communication apparatus through a wire circuit before a predetermined period of time elapses after setting for performing communication with the different information communication apparatus through the network is started, the third information communication apparatus transmits the communication information set in advance in the third information communication apparatus itself to the different information communication apparatus through the wire circuit.

The third information communication apparatus may be any information communication apparatus which communicates with the different information communication apparatus through the network.

Accordingly, the third information communication apparatus may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the information communication system may involve radio communication used in a certain interval and wire information used in another certain interval.

According to a yet further aspect of the present invention, there is provided a fourth information communication apparatus which communicates with a different information communication apparatus connected to a network through the network, including connection means for establishing a connection to the different information communication apparatus through a wire circuit, transmission control means for controlling, when setting for performing communication with the different information communication apparatus through the network is started, transmission of request information for requesting for communication information necessary for communication through the network to the different information communication apparatus through the connection means and the wire circuit, reception control means for controlling, when the communication information is transmitted from the different information communication apparatus to the information communication apparatus through the wire circuit in response to the request information transmitted under the control of the transmission control means, reception of the communication information through the connection means, and setting means for setting the communication information to the information communication apparatus when the reception of the communication information by the reception control means comes to an end before a predetermined period of time elapses after the setting is started.

According to a yet further aspect of the present invention, there is provided an information communication method for a fourth information communication apparatus which communicates with a different information communication apparatus connected to a network through the network, including a transmission control step of controlling, when setting for performing communication with the different information communication apparatus through the network is started by the fourth information communication apparatus, transmission of request information for requesting for communication information necessary for communication through the network to the different information communication apparatus through the wire circuit, a reception control step of controlling, when the communication information is transmitted from the different information communication apparatus to the information communication apparatus through the wire circuit in response to the request information transmitted under the control of the process at the transmission control step, reception of the communication information by the information communication apparatus, and a setting step of setting the communication information to the fourth information communication apparatus when the reception of the communication information by the process at the reception control step comes to an end before a predetermined period of time elapses after the setting is started.

According to a yet further aspect of the present invention, there is provided a fourth program for causing a computer, which controls an information communication apparatus which communicates with a different information communication apparatus connected to a network through the network, to execute a transmission control step of controlling, when setting for performing communication with the different information communication apparatus through the network is started by the information communication apparatus, transmission of request information for requesting for communication information necessary for communication through the network to the different information communication apparatus through the wire circuit, a reception control step of controlling, when the communication information is transmitted from the different information communication apparatus to the information communication apparatus through the wire circuit in response to the request information transmitted under the control of the process at the transmission control step, reception of the communication information by the information communication apparatus, and a setting step of setting the communication information to the information communication apparatus when the reception of the communication information by the process at the reception control step comes to an end before a predetermined period of time elapses after the setting is started.

In the fourth information communication apparatus and method and the fourth program, when setting for performing communication with a different information communication apparatus through a network is started by the fourth information communication apparatus, request information for requesting for communication information necessary for communication through the network is transmitted from the information communication apparatus to the different information communication apparatus through the wire circuit. Then, when the communication information corresponding to the request information and transmitted from the different information communication apparatus is received by the fourth information communication apparatus through a wire circuit before a predetermined period of time elapses after the setting is started, the communication information is set to the fourth information communication apparatus.

The fourth information communication apparatus may be any information communication apparatus which communicates with the different information communication apparatus through the network.

Accordingly, the fourth information communication apparatus may be any of, for example, an information communication apparatus which can communicate with another information communication apparatus by wire communication, another information communication apparatus which can communicate with a different information communication apparatus by radio communication or by both of wire communication and radio communication, and a further information communication apparatus which can communicate with a first different information communication apparatus by wire communication and can communicate with a second different information communication apparatus by radio communication. In other words, the information communication system may involve radio communication used in a certain interval and wire information used in another certain interval.

It is to be noted that naturally the present invention can be applied also to a recording medium on or in which any of the programs according to the present invention is recorded.

In summary, according to the present invention, an information communication apparatus can first perform setting for radio communication with a particular opposite party for communication and then communicate with the opposite party for communication based on the setting. Particularly, setting necessary for communication with a different information communication apparatus with which the user of the information communication apparatus wants to communicate can be performed with certainty making use of an operation system familiar to the user, and also the security level in communication in which the setting is used can be raised.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an example of a construction of an information communication system to which the present invention is applied;

FIG. 2 is a block diagram illustrating a method for setting of communication by the information communication system of FIG. 1;

FIG. 3 is a front elevational view showing an example of an appearance of a radio communication apparatus of an access point shown in FIG. 1;

FIG. 4 is a rear elevational view showing the example of the appearance of the radio communication apparatus of FIG. 3;

FIG. 5 is a block diagram showing an example of a detailed construction of the radio communication apparatus shown in FIG. 3;

FIG. 6 is a block diagram showing an example of a detailed construction of an information repeating apparatus of the access point shown in FIG. 1;

FIG. 7 is a front elevational view showing an example of a construction of an appearance of a radio communication apparatus connected to an information processing apparatus shown in FIG. 1;

FIG. 8 is a rear elevational view showing the example of the construction of the radio communication apparatus shown in FIG. 7;

FIG. 9 is a block diagram showing an example of a construction of the radio communication apparatus connected to an information processing apparatus shown in FIG. 1;

FIG. 10 is a functional block diagram showing an example of a construction of software for executing a setting function for radio communication of the radio communication apparatus connected to the information processing apparatus shown in FIG. 1 and the radio communication apparatus of the access point shown in FIG. 1;

FIG. 11 is a flow chart illustrating an example of a setting process for radio communication of the radio communication apparatus of the access point shown in FIG. 1;

FIG. 12 is a flow chart illustrating an example of a setting process for radio communication of the radio communication apparatus connected to the information processing apparatus shown in FIG. 1;

FIG. 13 is an arrow chart illustrating a relationship between examples of setting processes for radio communication of the radio communication apparatus of the access point shown in FIG. 1 and the radio communication apparatus connected to the information processing apparatus shown in FIG. 1; and

FIGS. 14 and 15 are block diagrams showing different examples of a setting of the information communication apparatus which composes an information communication system to which the present invention is applied.

### DESCRIPTION OF THE PREFERRED EMBODIMENT

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

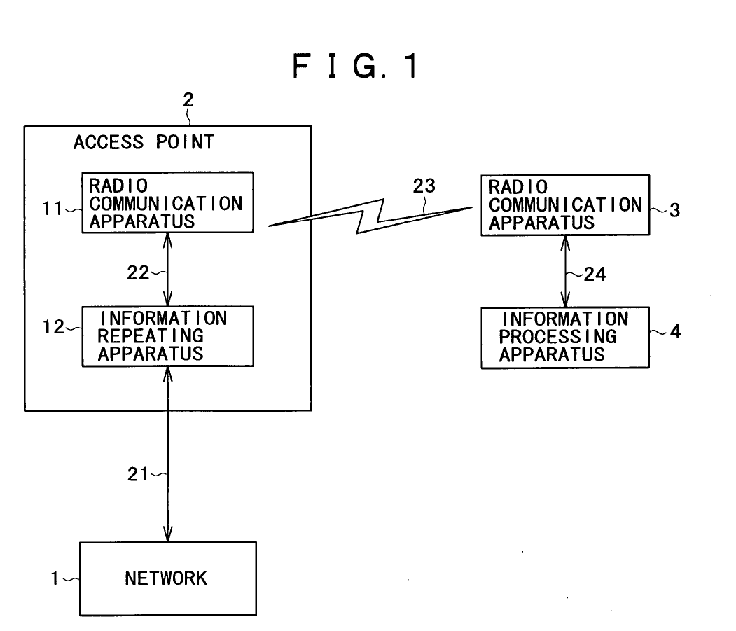

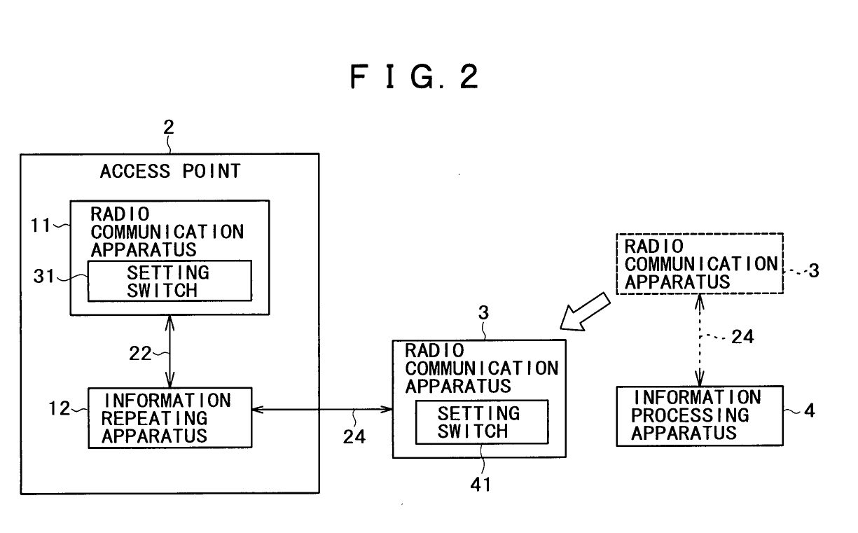

The information communication system (for example, an information communication system of FIG. 1) according to claim 1 includes two or more information communication apparatuses (for example, an access point 2 (radio communication apparatus 11) and a radio communication apparatus 3 of FIG. 1) connected to each other by a network (for example, a radio network which uses a radio circuit 23 of FIG. 1) and including first and second information communication apparatus (for example, the access point 2 (radio communication apparatus 11) and the radio communication apparatus 3 of FIG. 1, respectively). The first information communication apparatus has communication information necessary for communication through the network set therein in advance. The first information communication apparatus is connected to the second information communication apparatus by a wire circuit (for example, by a wire circuit 24 (and an information repeating apparatus 12 and another wire circuit 22 as shown in FIG. 2). The first and second information apparatuses are operable, when a predetermined signal based on an operation of a user is inputted individually to the first and second information apparatuses (for example, a setting switch 31 and another setting switch 41 of FIG. 2 are depressed, respectively), such that the first information communication apparatus transmits the communication information to the second information communication apparatus through the wire circuit and the second information communication apparatus sets the communication information transmitted thereto from the first information communication apparatus, whereafter the first and second information communication apparatus utilize the communication information set therein to perform communication therebetween (for example, they perform radio communication with each other through a radio circuit 23 in the state of FIG. 1).

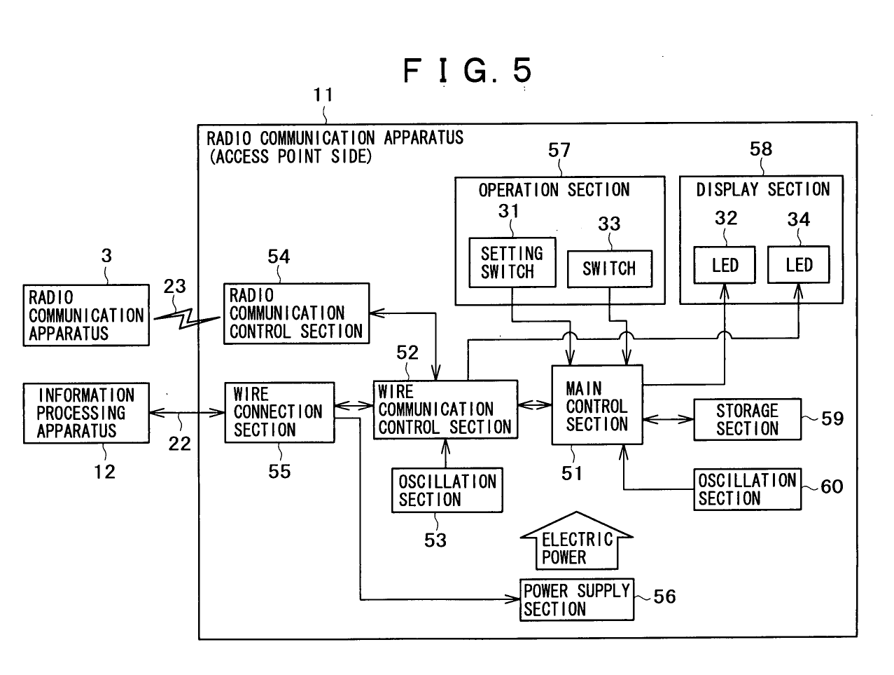

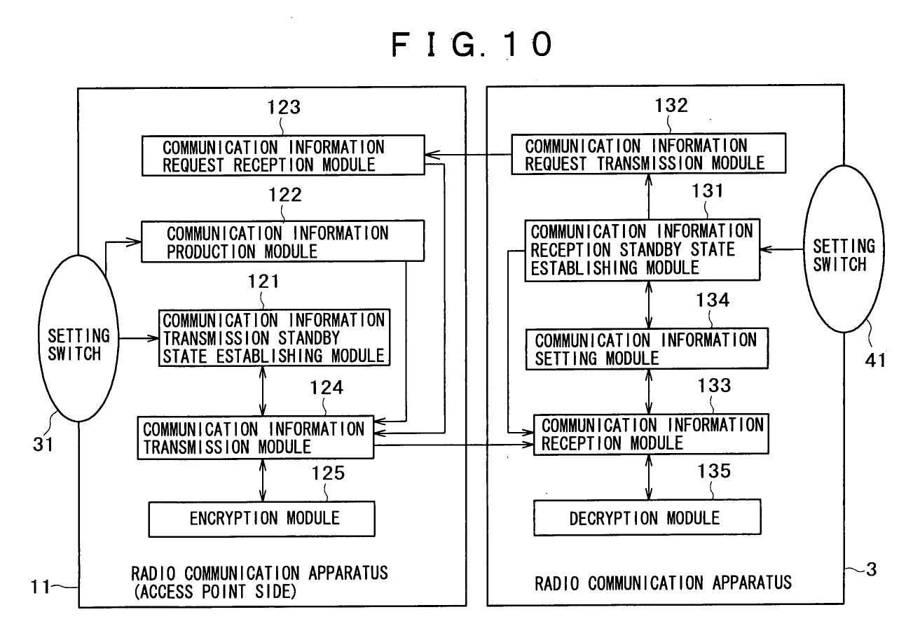

The information communication apparatus according to claim 3 (for example, an information communication apparatus 11 of an access point 2 of FIG. 1 (or, for example, the access point 2 including the information communication apparatus 11) communicates with a different information communication apparatus (for example, a radio communication apparatus 3 of FIG. 1) connected to a network (for example, a radio network which uses a radio circuit 23 of FIG. 1) through the network, and includes connection means (for example, a wire connection section 55 of a radio communication apparatus 11 of FIG. 5 (or an information repeating apparatus 12 of an access point 2 of FIG. 1)) for establishing a connection to the different information communication apparatus through a wire circuit (for example, a wire circuit 22, the information repeating apparatus 12 and another wire circuit 24 of FIG. 2 (or the wire circuit 24)), input means (for example, a setting switch 31 of FIG. 5) for inputting a trigger signal to start setting necessary for the information communication apparatus to communicate with the different information communication apparatus through the network, and transmission control means (for example, a main control section 5 of FIG. 5 which executes a communication information transmission module 124 of FIG. 10) for controlling, when a request for transmission of communication information necessary for communication through the network is received from the different information communication apparatus connected to the connection means through the wire circuit after the trigger signal is inputted from the input means, transmission of the communication information set in advance in the information communication apparatus to the different information communication apparatus through the connection means and the wire circuit.

The information communication apparatus according to claim 9 further includes encryption means (for example, a main control section 51 of FIG. 5 which executes an encryption module 125 of FIG. 10) for encrypting the communication information at least once, the transmission control means controlling the transmission of the communication information encrypted by the encryption means.

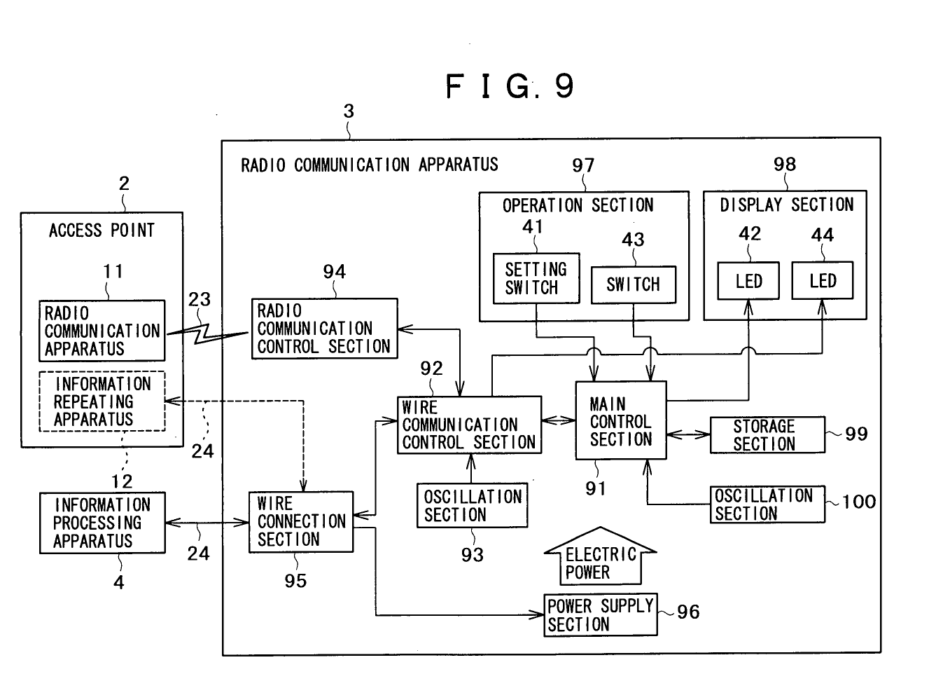

The information communication apparatus according to claim 12 (for example, a radio communication apparatus 3 of FIG. 1) communicates with a different information communication apparatus (for example, a radio communication apparatus 11 of an access point 2 of FIG. 1 (or the access point 2 including the radio communication apparatus 11)) connected to a network (for example, a radio network which uses a radio circuit 23 of FIG. 1) through the network, and includes connection means (for example, a wire connection section 95 of FIG. 9) for establishing a connection to the different information communication apparatus through a wire circuit (for example, a wire circuit 24, an information repeating apparatus 12 and another wire circuit 22 of FIG. 2 (or the wire circuit 24)), input means (for example, a setting switch 41 of FIG. 9) for inputting a trigger signal to start setting necessary for the information communication apparatus to communicate with the different information communication apparatus through the network, transmission control means (for example, a main control section 91 of FIG. 9 which executes a communication information request transmission module 132 of FIG. 10) for controlling, after the trigger signal is inputted from the input means, transmission of request information for requesting for communication information necessary for communication through the network to the different information communication apparatus through the connection means and the wire circuit, reception control means (for example, the main control section 91 of FIG. 9 which executes a communication information reception module 133 of FIG. 10) for controlling, when the communication information is transmitted from the different information apparatus to the information communication apparatus through the wire circuit in response to the request information transmitted under the control of the transmission control means, reception of the communication information through the connection means, and setting means (for example, the main control section 91 of FIG. 9 which executes a communication information setting module 134 of FIG. 10) for setting the communication information received under the control of the reception control means.

The information communication apparatus according to claim 14 (for example, a radio communication apparatus 3 of FIG. 1 which has a construction of FIG. 9) further includes conversion means (for example, a wire communication control section 92 and a radio communication control section 94 of FIG. 9) for converting a signal transmitted through the radio network to the information communication apparatus into a signal which can be transmitted by the wire circuit and converting a signal transmitted through the wire circuit into a signal which can be transmitted in the radio network.

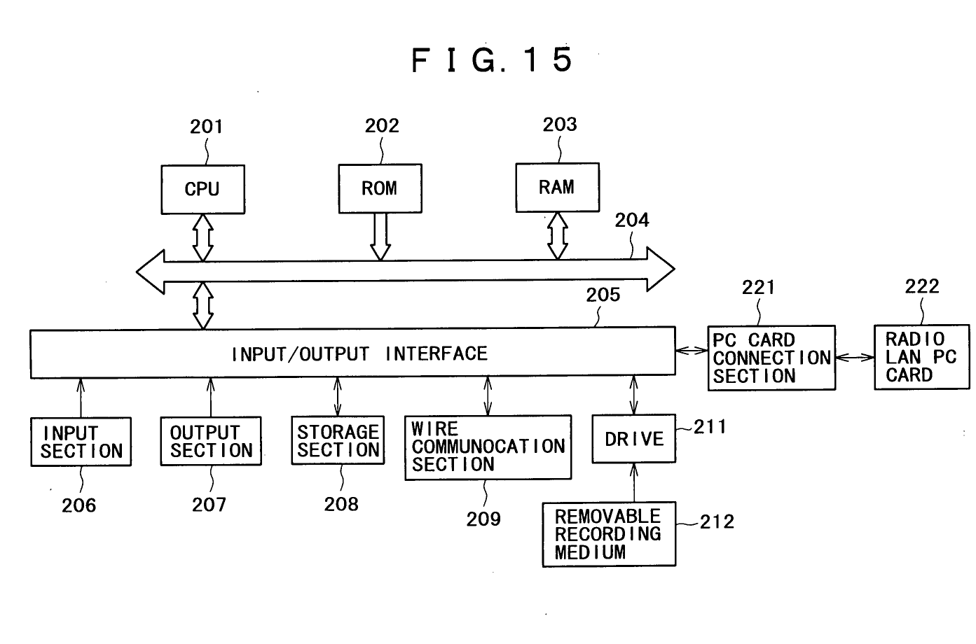

The information communication apparatus according to claim 15 is constructed such that the information communication apparatus is a personal computer card for a radio local area network (for example, a radio LAN PC card 222 of FIG. 15).

The information communication apparatus according to claim 20 is constructed such that the communication information received under the control of the reception control means is encrypted at least once, the information communication apparatus further including decryption means (for example, a main control section 91 of FIG. 9 which executes a decryption module of FIG. 10) for decrypting the encrypted communication information received under the control of the reception control means, the setting means sets the communication information decrypted by the decryption means.

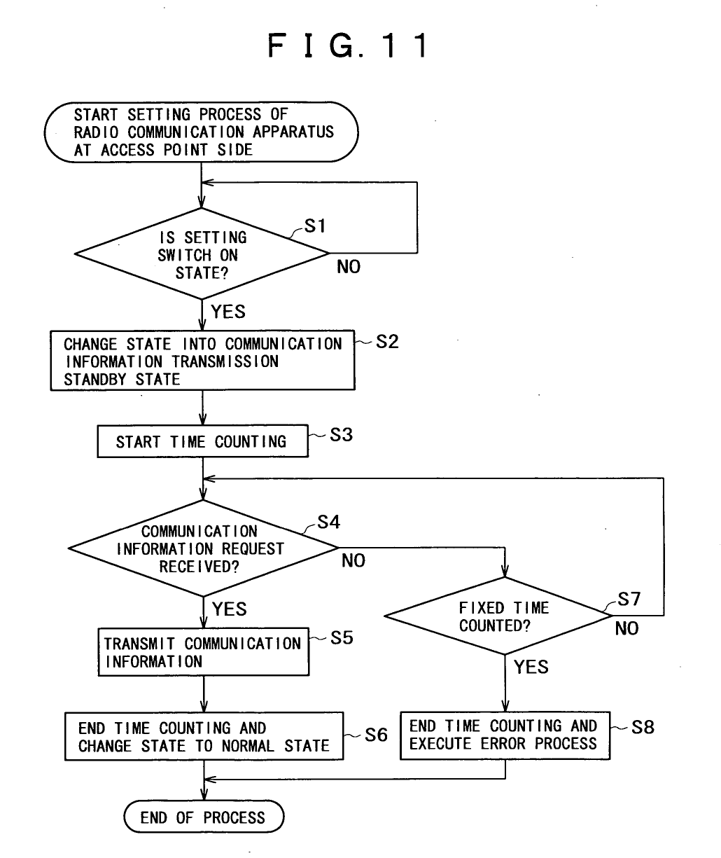

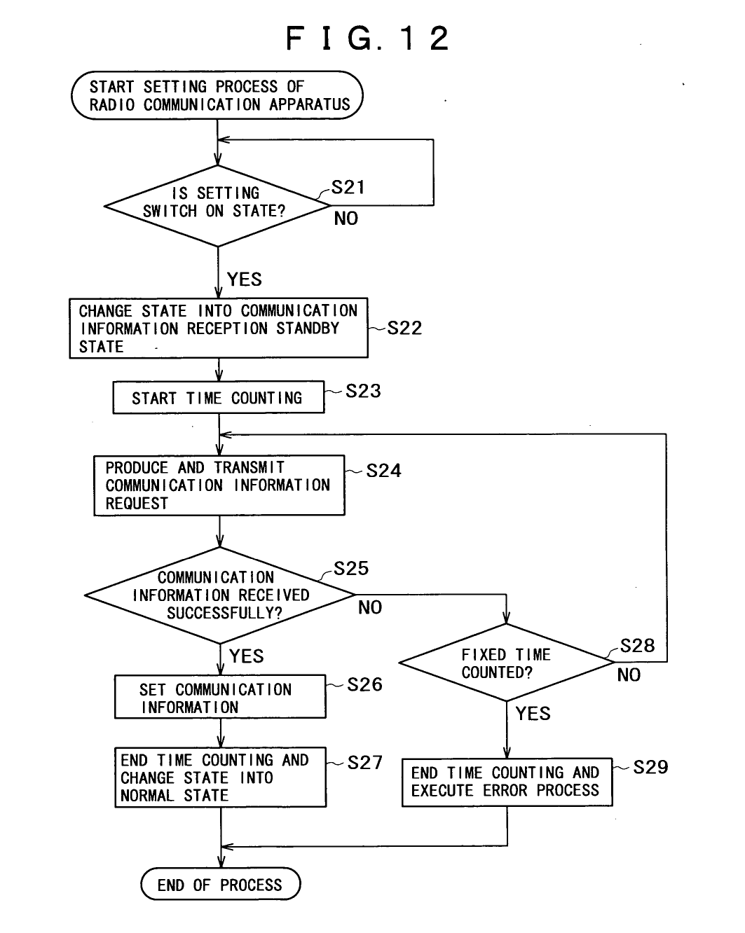

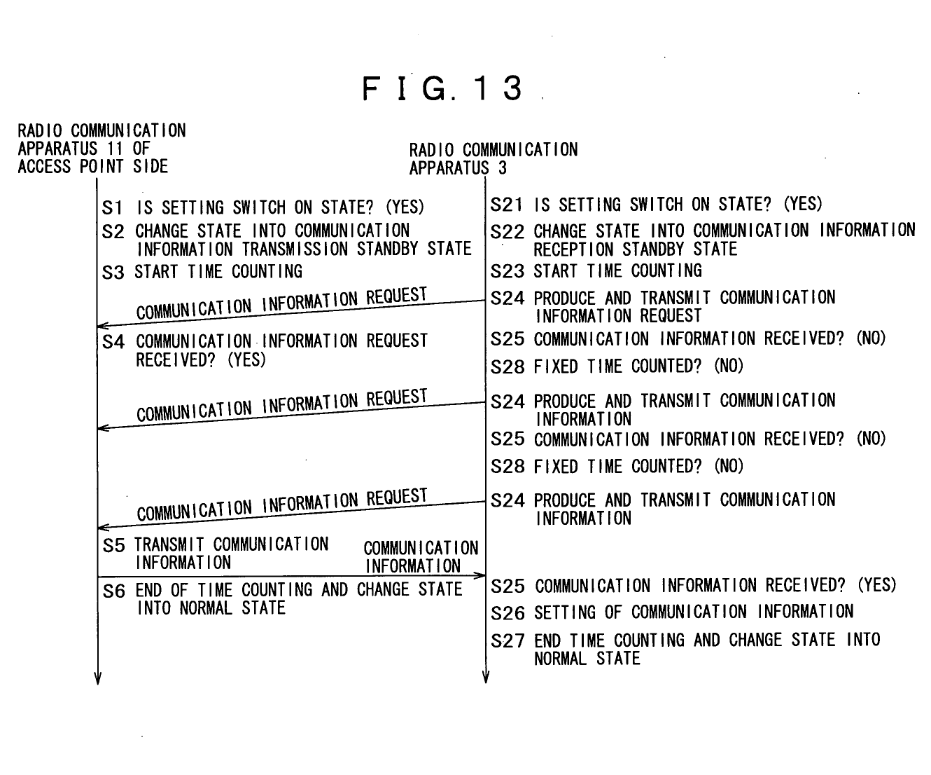

The information communication system according to claim 23 (for example, an information communication system of FIG. 1) includes two or more information communication apparatuses (for example, an access point 2 (radio communication apparatus 11) and a radio communication apparatus 3 of FIG. 1) connected to each other by a network and including first and second information communication apparatus (for example, the access point 2 (radio communication apparatus 3) and the radio communication apparatus 3 of FIG. 1, respectively). The first information communication apparatus has communication information necessary for communication through the network set therein in advance. The first information communication apparatus transmits, when a request for transmission of the communication information is received from the second information communication apparatus through a wire circuit (for example, a wire circuit 24 (and an information repeating apparatus 12 and another wire circuit 22) of FIG. 2) before a predetermined first period of time (for example, a predetermined period of time after a setting switch 31 of FIG. 5 is depressed) elapses after the first information communication apparatus starts setting for performing communication with the second information communication apparatus through the network, the communication information to the second information communication apparatus through the wire circuit (for example, executes processes at steps S1 to S5 of FIGS. 11 and 13). The second information communication apparatus sets, when the communication information for which the second information communication apparatus has requested to the first information communication apparatus through the wire circuit is transmitted to the second information communication apparatus from the first information communication apparatus through the wire circuit before a predetermined second period of time (for example, a predetermined period of time after a setting switch 41 of FIG. 9 is depressed) elapses after setting for performing communication with the first information communication apparatus through the network is started, the communication information transmitted thereto from the first information communication apparatus (for example, executes processes at steps S21 to S28 of FIGS. 12 and 13). The first and second communication apparatus thereafter utilize the communication information set therein to perform communication therebetween (for example, perform radio communication with each other through a radio circuit 23 in a state of FIG. 1).

The information communication apparatus according to claim 25 (for example, an information communication apparatus 11 of an access point 2 of FIG. 1 (or the access point 2 including the information communication apparatus 11) which communicates with a different information communication apparatus (for example, a radio communication apparatus 3 of FIG. 1) connected to a network (for example, a radio network which uses a radio circuit 23 of FIG. 1) through the network, and includes connection means (for example, a wire connection section 55 of a radio communication apparatus of FIG. 5 (or the information repeating apparatus 12 of the access point 2 of FIG. 1)) for establishing a connection to the different information communication apparatus through a wire circuit, and transmission control means (for example, a main control section 51 of FIG. 5 which executes a communication information transmission module 124 of FIG. 10) for controlling, when a request for transmission of communication information necessary for communication through the network is received from the different information communication apparatus connected to the connection means through the wire circuit before a predetermined period of time elapses after setting for performing communication with the different information communication apparatus through the network is started (for example, after time counting is started by a process at step S3 after it is discriminated by a process at step S1 of FIGS. 11 and 13 that a setting switch 31 of FIG. 5 is in an on state and then the state of the information communication apparatus is changed to a communication information transmission standby state by a process at step S2), transmission of the communication information set in advance in the information communication apparatus to the different information communication apparatus through the connection means and the wire circuit.

The information communication apparatus according to claim 28 (for example, a radio communication apparatus 3 of FIG. 1) communicates with a different information communication apparatus (for example, a radio communication apparatus 11 of an access point 2 of FIG. 1 (or the access point 2 including the radio communication apparatus 1) connected to a network (for example, a radio network which uses a radio circuit 23 of FIG. 1) through the network, and includes connection means (for example, a wire connection section 95 of FIG. 9) for establishing a connection to the different information communication apparatus through a wire circuit (for example, a wire circuit 24, an information repeating apparatus 12 and another wire circuit 22 of FIG. 2 (or the wire circuit 24)), transmission control means (for example, a main control section 91 of FIG. 9 which executes a communication information request transmission module 132 of FIG. 10) for controlling, when setting for performing communication with the different information communication apparatus through the network is started (for example, after time counting is started by a process at step S23 after it is discriminated by a process at step S21 of FIGS. 12 and 13 and then the state of the information communication apparatus is changed to a communication information reception standby state by a process at step S22), transmission of request information for requesting for communication information necessary for communication through the network to the different information communication apparatus through the connection means and the wire circuit (for example, transmission of a communication information request by a process at step S24 of FIGS. 12 and 13), reception control means (for example, the main control section 91 of FIG. 9 which executes a communication information reception module 133 of FIG. 10) for controlling, when the communication information is transmitted from the different information communication apparatus to the information communication apparatus through the wire circuit in response to the request information transmitted under the control of the transmission control means, reception of the communication information through the connection means, and setting means (for example, the main control section 91 of FIG. 9 which executes a communication information setting module 134 of FIG. 10) for setting the communication information to the information communication apparatus (for example, executing a process at step S26 of FIGS. 12 and 13) when the reception of the communication information by the reception control means comes to an end (for example, it is discriminated by a process at step S25 of FIGS. 12 and 13 that the communication information is received successfully) before a predetermined period of time elapses after the setting is started.

Referring to FIG. 1, there is shown an example of a construction of an information communication system to which the present invention is applied.

In the information communication system to which the present invention is applied, an access point 2 connected to an external network 1 by a wire circuit 21 and a radio communication apparatus 3 connected to an external information processing apparatus 4 by another wire circuit 24 perform radio communication through a radio circuit 23 therebetween. In other words, the information communication system to which the present invention is applied includes the access point 2 and the radio communication apparatus 3 and can be applied, for example, where the external information processing apparatus 4 performs communication with another information processing apparatus (not shown) connected to the external network 1.

It is to be noted that, in the information communication system of FIG. 1, only one access point 2 and only one radio communication apparatus 3 are shown for the simplified illustration and description. Naturally, however, the information communication system to which the present invention is applied can include a plurality of access points including the access point 2 and a plurality of radio communication apparatus including the radio communication apparatus 3.

In other words, in the information communication system to which the present invention is applied, a radio network including such a 1:1 communication form as shown in FIG. 1 is constructed, and radio communication is performed through the radio network.

The access point 2 includes a radio communication apparatus 11 which performs radio communication with the radio communication apparatus 3 through the radio circuit 23 and an information repeating apparatus 12 which repeats information to be transferred between the radio communication apparatus 11 and the network 1.

The information repeating apparatus 12 is connected to the network 1 through the wire circuit 21 and connected to the radio communication apparatus 11 through a wire circuit 22, and supplies information supplied thereto from the network 1 through the wire circuit 21 to the radio communication apparatus 11 through the wire circuit 22. Further, the information repeating apparatus 12 supplies information supplied thereto from the radio communication apparatus 11 through the wire circuit 22 to the network 1 through the wire circuit 21.

The radio communication apparatus 11 supplies information supplied thereto through the wire circuit 22, that is, information supplied thereto from the network 1 through the wire circuit 21, information repeating apparatus 12 and wire circuit 22, to the radio communication apparatus 3 through the radio circuit 23. Further, the radio communication apparatus 11 supplies information supplied thereto through the radio circuit 23, that is, information supplied thereto from the radio communication apparatus 3 through the radio circuit 23, to the information repeating apparatus 12 through the wire circuit 22. In other words, the radio communication apparatus 11 is a converter which converts a signal transmitted thereto through a radio network which utilizes the radio circuit 23 into a signal which can be transmitted by the wire circuit 22 and converts a signal transmitted thereto through the wire circuit 22 into a signal which can be transmitted in a radio network which utilizes the radio circuit 23.

The radio communication apparatus 3 supplies information transmitted thereto through the wire circuit 24, that is, information supplied thereto from the information processing apparatus 4 through the wire circuit 24, to the radio communication apparatus 11 through the radio circuit 23. Further, the radio communication apparatus 3 supplies information transmitted thereto through the radio circuit 23, that is, information supplied thereto from the radio communication apparatus 11 through the radio circuit 23, to the information processing apparatus 4 through the wire circuit 24. In other words, also the radio communication apparatus 3 is a converter which converts a signal transmitted thereto through a radio network which utilizes the radio circuit 23 into a signal which can be transmitted by the wire circuit 24 and converts a signal transmitted thereto through the wire circuit 24 into a signal which can be transmitted within a radio network which utilizes the radio circuit 23.

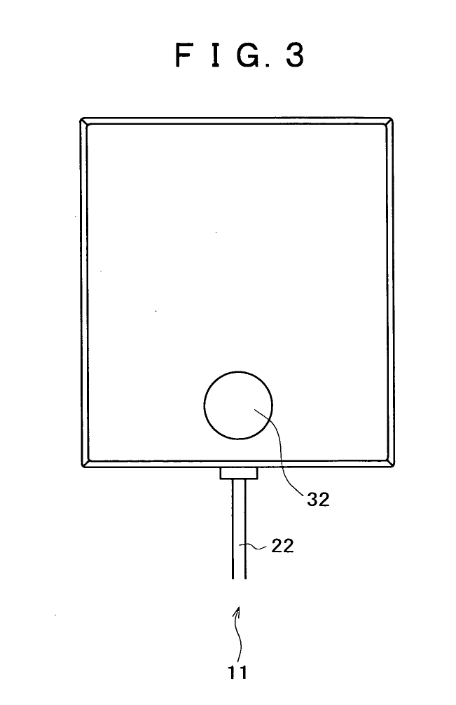

Accordingly, where the wire circuit 22 and the wire circuit 24 are used in accordance with the same communication system (standards), the radio communication apparatus 3 and the radio communication apparatus 11 can be formed as apparatus which have constructions and functions basically similar to each other as hereinafter described, for example, with reference to FIGS. 3 to 5 or FIGS. 7 to 9.

The forms of the network 1 and the information processing apparatus 4 are not limited particularly and may individually be various forms. For example, as the network 1, the Internet or the Ethernet (registered trademark) can be applied. Meanwhile, as the information processing apparatus 4, for example, it is possible to apply a personal computer or otherwise apply a household electric appliance such as a television receiver, a video tape recorder or a hard disk recorder.

It is to be noted that, in the following description, it is assumed that the network 1 is the Ethernet (registered trademark). In other words, in this instance, the standards prescribed by the Ethernet (registered trademark) are adopted for the communication system for wire communication.

Also the radio communication system for radio communication is not limited particularly, and for example, such standards as those of the Bluetooth may be adopted. In the following description, however, it is assumed that the standards of the IEEE 802.11a, 802.11b or 802.11g are adopted.

Subsequently, an outline of a process for setting for radio communication in the information communication system of the present embodiment is described with reference to FIG. 2. It is to be noted that details of a process for setting for radio communication are hereinafter described as setting processes for different radio communication apparatus (the radio communication apparatus 3 and the radio communication apparatus 11) with reference to FIGS. 11 to 13.

FIG. 2 illustrates a setting method for radio communication in the information communication system of the present embodiment, that is, a setting method where the radio communication apparatus 11 of the access point 2 of FIG. 1 and the radio communication apparatus 3 connected to the information processing apparatus 4 perform radio communication with each other.

Here, to set information (hereinafter referred to as communication information) necessary for construction of a radio network to individual radio communication apparatus (in the present case, the radio communication apparatus 11 and the radio communication apparatus 3) connected to the radio network is referred to as setting for radio communication.

In this instance, the types of communication and the number of the types are not limited particularly. Here, however, it is assumed that the communication information includes two different types of information including identification information of a radio network to be constructed and information regarding the security. Also the types of the identification information and the information regarding the security and the number of such types and security information are not limited particularly. Here, however, since the standards of the IEEE 802.11a, 802.11b or 802.11g are adopted as the radio communication system, it is assumed that, for example, an SSID is adopted as the identification information and a WEP key is adopted as the information regarding the security.

Referring to FIG. 2, when the radio communication apparatus 3 tries to perform radio communication with the radio communication apparatus 11 (access point 2) for the first time or when updating the setting for radio communication is to be performed, the user will disconnect one end of the wire circuit 24 from the information processing apparatus 4 (where the wire circuit 24 has been connected to the information processing apparatus 4) and connect the disconnected end of the wire circuit 24 to the information repeating apparatus 12. Consequently, the radio communication apparatus 3 and the access point 2 are connected to each other physically (by a wire) through the wire circuit 24. In other words, the radio communication apparatus 3 and the radio communication apparatus 11 are connected to each other physically (by a wire) through the wire circuit 24, information repeating apparatus 12 and wire circuit 22. In other words, the radio communication apparatus 3 and the radio communication apparatus 11 function as wire communication apparatus and perform wire communication with each other.

In this instance, if setting for radio communication is started immediately at a point of time when the radio communication apparatus 3 and the radio communication apparatus 11 are connected to each other, that is, using the connection as a trigger, then the third and fourth subjects of the conventional apparatus described hereinabove take place.

Therefore, in the present embodiment, a switch 31 which generates a trigger signal for starting setting for radio communication in response to a depression operation thereof by the user (a switch of the type described is hereinafter referred to as setting switch) is provided on the radio communication apparatus 11 while another setting switch 41 is provided on the radio communication apparatus 3.

If the setting switch 31 and the setting switch 41 are depressed, that is, trigger signals based on operations of the user are inputted to the radio communication apparatus 3 and the radio communication apparatus 11 while the radio communication apparatus 3 and the radio communication apparatus 11 are connected to each other by a wire circuit, that is, the radio communication apparatus 3 and the radio communication apparatus 11 are connected to each other through the wire circuit 24, information repeating apparatus 12 and wire circuit 22 as seen in FIG. 2, then communication information set in advance in the radio communication apparatus 11, that is, in the present case, an SSID and a WEP key, is supplied from the radio communication apparatus 11 to the radio communication apparatus 3 through the wire circuit 22, information repeating apparatus 12 and wire circuit 24. Then, as the radio communication apparatus 3 sets the communication information supplied thereto into the radio communication apparatus 3 itself, the setting for radio communication is completed.

After the setting for radio communication is completed in this manner, the radio communication apparatus 11 and the radio communication apparatus 3 can perform radio communication with each other. Accordingly, if the user disconnects one end of the wire circuit 24 from the information repeating apparatus 12 and connects the disconnected end of the wire circuit 24 to the information processing apparatus 4, that is, if the state illustrated in FIG. 1 is restored, then the information processing apparatus 4 can perform mutual communication with another information apparatus (not shown) connected to the network 1 through the radio communication apparatus 3, access point 2 (radio communication apparatus 11 and information repeating apparatus 12) and network 1.

It is to be noted that, where communication information such as an SSID and a WEP key is set in advance in the radio communication apparatus 11 of the access point 2, the access point 2 can produce communication information by itself and set it into the access point 2 itself as hereinafter described. Although triggering to the process just described (the process of production and setting of communication information by the access point 2) is not limited particularly, it is assumed here that the process is started using, for example, the fact that the setting switch 31 is kept depressed for more than a fixed period of time as a trigger.

In this manner, according to the present embodiment, the user can perform setting for radio communication between the radio communication apparatus 3 and the access point 2 (radio communication apparatus 11) only by performing simple operations of connecting the radio communication apparatus 3 and the access point 2 to each other through the wire circuit 24, that is, connecting the radio communication apparatus 3 and the radio communication apparatus 11 to each other through the wire circuit 24, information repeating apparatus 12 and wire circuit 22, and depressing the setting switch 31 of the radio communication apparatus 11 and the setting switch 41 of the radio communication apparatus 3. In other words, the first and second subjects of the conventional apparatus described hereinabove can be solved.

Further, in the present embodiment, setting for radio communication is not started immediately when the radio communication apparatus 3 and the access point 2 (radio communication apparatus 11) are connected to each other, but a logical AND condition of the connection and depression of the setting switch 31 and the setting switch 41 is used as a trigger to start setting for radio communication. Therefore, the user can perform setting for radio communication after objects of the radio communication (the radio communication apparatus 11 and the radio communication apparatus 3) are confirmed actually by depressing the setting switch 31 and the setting switch 41. Consequently, the safety in radio communication after the setting can be anticipated. In other words, the third and fourth subjects of the conventional apparatus can be solved.

It is to be noted that, while, in the present embodiment, the setting switch 31 and the setting switch 41 are formed as hardware switches for exclusive use, they may otherwise be formed as software switches, or some other switches having different functions which may be software or hardware may be used also as the switches.

It is to be noted, however, where the setting switch 31 or the setting switch 41 is a software switch, a display section for displaying the switch thereon and an operation section for operating the switch displayed on the display section are required as components of the radio communication apparatus 11 or the radio communication apparatus 3.

On the other hand, where the setting switch 31 or the setting switch 41 is used also as a switch for some other function, if the setting switch 31 of the radio communication apparatus 11 is depressed by some reason and the user depresses the setting switch 41 of the radio communication apparatus 3 in the state illustrated in FIG. 2, then setting for radio communication is started irrespective of whether or not the user intends to perform setting for radio communication, that is, even if the setting switch 41 is depressed in order to utilize the different function or is depressed in error. In this instance, when the setting for radio communication is completed while the user does not become aware of the operation in error or when the setting for radio communication is completed only after the user becomes aware, the radio communication apparatus 11 and the radio communication apparatus 3 are in a state wherein they can communicate with each other any time. Consequently, the safety in radio communication cannot be achieved. In other words, the third and fourth subjects described hereinabove take place. Accordingly, it is preferable to construct the setting switch 31 and the setting switch 41 individually as hardware (or software) switches for exclusive use.

Further, where the setting switch 31 and the setting switch 41 are provided as switches for exclusive use, the user can recognize the functions of the switches readily. In other words, the user can understand readily that the setting switch 31 and the setting switch 41 are switches for exclusive use for setting radio communication. Therefore, the user can feel that the operations for setting for radio communication are easy. In other words, the first and second subjects can be solved.

Furthermore, the order of depression operations of the setting switch 31 and the setting switch 41 is not limited particularly, but only it is necessary that one of the setting switch 31 and the setting switch 41 be depressed before a predetermined period of time elapses after the other of them is depressed as hereinafter described. Also such flexibility in operation can cause the user to feel that the operations for setting the radio communication are easy. In other words, the first and second subjects can be solved.

Now, examples of detailed constructions of the radio communication apparatus 11 of the access point 2, the information repeating apparatus 12 and the radio communication apparatus 3 connected to the information processing apparatus 4 are described individually in order with reference to FIGS. 3 to 9.

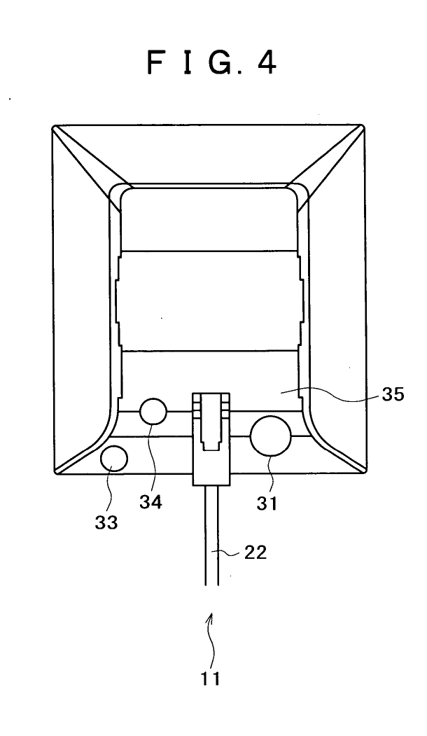

FIGS. 3 and 4 show an example of an appearance of the radio communication apparatus 11 of the access point 2. More particularly, FIGS. 3 and 4 are a front elevational view and a rear elevational view of the radio communication apparatus 11, respectively.

Referring first to FIG. 3, a light emitting diode (LED 32) is provided at a lower portion of a front face in FIG. 3 of the radio communication apparatus 11, and the wire circuit 22 is connected to one of side faces perpendicular to the front face which is positioned below the LED 32 in FIG. 3. In this instance, the wire circuit 22 particularly is, for example, a LAN cable for the Ethernet (registered trademark).

FIG. 4 shows a rear face of the radio communication apparatus 11 to which a cover 35 is attached, that is, a face of the radio communication apparatus 11 opposite to the front face of FIG. 3. A switch 33, another LED 34 and the setting switch 31 described hereinabove are provided in order from the left at a lower portion of the rear face of the radio communication apparatus 11. The switch 33 has a function allocated thereto which is different from the function for setting for radio communication, that is, a function different from the function of the setting switch 31 is allocated to the switch 33. More particularly, for example, if the switch 33 is depressed, then a setting upon shipment from a factory is restored.

FIG. 5 is a block diagram showing an example of an internal construction of the radio communication apparatus 11 of the access point 2.

Referring to FIG. 5, a main control section 51 controls operation of the entire radio communication apparatus 11 in synchronism with a clock of a predetermined frequency such as, for example, 48 MHz oscillated from an oscillation section 60.

A wire communication control section 52 controls, under the control of the main control section 51, wire communication with a different information processing apparatus (in the present case, the information repeating apparatus 12) connected to a wire connection section 55 through the wire circuit 22 in synchronism with a clock of a predetermined frequency (for example, 25 MHz) oscillated from an oscillation section 53.

An end of the wire circuit 22 is connected to the wire connection section 55. In other words, the wire connection section 55 is an interface with a different wire communication apparatus (in the present case, the information repeating apparatus 12) to which the other end of the wire circuit 22 is connected. More particularly, for example, in the present case, since the wire circuit 22 is a LAN cable for the Ethernet (registered trademark), the wire connection section 55 is a port for connection of a terminal of the LAN cable for the Ethernet (registered trademark).

A radio communication control section 54 controls radio communication with a different radio communication apparatus (in the present case, the radio communication apparatus 3), connected thereto through a radio network which uses the radio circuit 23.

In particular, the radio communication control section 54 and the wire communication control section 52 convert information transmitted thereto from the radio communication apparatus 3 through the radio circuit 23 into a signal for wire transmission and supply the resulting signal to the information repeating apparatus 12 through the wire connection section 55 and the wire circuit 22. Further, the radio communication control section 54 and the wire communication control section 52 convert a signal transmitted through a wire circuit, that is, a signal transmitted from the information repeating apparatus 12 and received through the wire circuit 22 and the wire connection section 55, into a signal for radio transmission and transmits the resulting signal to the radio communication apparatus 3 through the radio circuit 23.

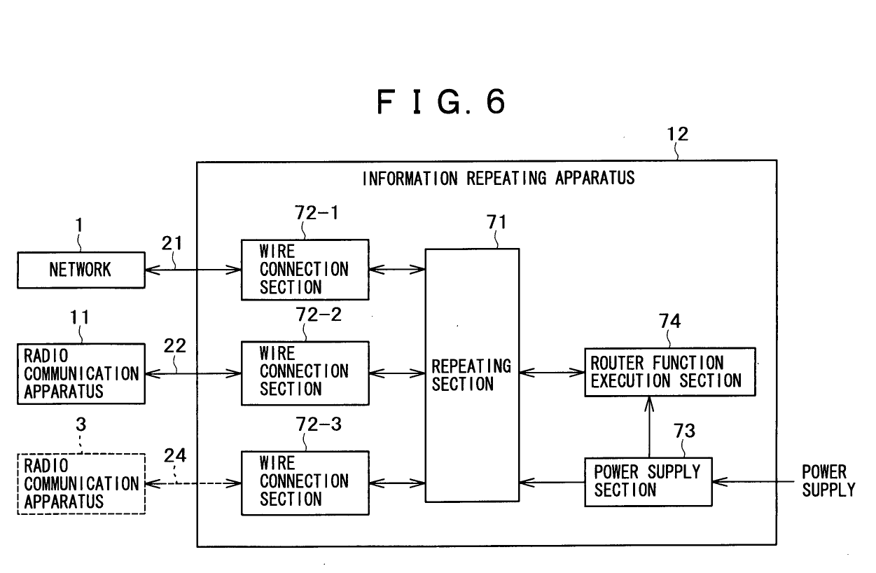

A power supply section 56 supplies electric power supplied thereto from an external power supply (FIG. 6) through the information repeating apparatus 12, wire circuit 22 and wire connection section 55 to the entire radio communication apparatus 11. It is to be noted that, while an arrow mark indicating that the electric power is supplied to the entire radio communication apparatus 11 is shown in FIG. 5, actually the power supply section 56 supplies the electric power with individually corresponding voltages to the individual components of the radio communication apparatus 11 such as a display section 58. More particularly, when a dc voltage of, for example, +12 V is applied from the wire connection section 55, the power supply section 56 produces a dc voltage of +3.3 V by means of a switching regulator built therein and outputs the dc voltage of +3.3 V to those components of the radio communication apparatus 11 which require the voltage. The power supply section 56 further produces another dc voltage of +1.8 V from the dc voltage of +3.3 V by means of a linear regulator built therein and supplies the dc voltage of +1.8 V to those components of the radio communication apparatus 11 which require the voltage.

In other words, the electric power to be used by the radio communication apparatus 11 is supplied from a different apparatus connected to the wire connection section 55 through the wire circuit 22. Accordingly, the connection of the radio communication apparatus 11 to a different apparatus (in the present instance, the information repeating apparatus 12) through the wire circuit 22 signifies also that the power supply to the radio communication apparatus 11 is placed into an on state.

An operation section 57 includes the setting switch 31 and the switch 33 described above and other necessary elements and supplies a signal based on an operation of the user thereof to the main control section 51.

The display section 58 includes the LED 32 and the LED 34 described hereinabove and other necessary elements and displays, for example, a state that information is being sent or received and so forth. It is to be noted here that the LED 32 is controlled by the main control section 51 while the LED 34 is controlled by the wire communication control section 52.

Though not shown, a storage section 59 includes, for example, a flash ROM (Read Only Memory) or an SDRAM (Synchronous Dynamic Random Access Memory) or else a combination of a flash ROM and an SDRAM and stores information (including programs) necessary for the main control section 51 to execute various processes.

In particular, the main control section 51 controls executions of various processes in accordance with a program loaded into the SDRAM from among programs recorded in the flash ROM. Also data and so forth necessary for the main control section 51 to execute various processes is suitably stored into the SDRAM.

FIG. 6 is a block diagram showing an example of a detailed construction of the information repeating apparatus 12 of the access point 2.

Referring to FIG. 6, the information repeating apparatus 12 include one or more wire connection sections 72, for example, three wire connection sections 72-1 to 72-3. The wire connection sections 72 are connected to each other physically (by a wire circuit) through a repeating section 71. In particular, the information repeating apparatus 12 repeats information to be exchanged to and from apparatus individually connected to the wire connection sections 72-1 to 72-3.

More particularly, for example, where, as shown in FIG. 6, one end of the wire circuit 21 is connected to the wire connection section 72-1 while the network 1 (different information processing apparatus not shown) is connected to the other end of the wire circuit 21 and one end of the wire circuit 22 is connected to the wire connection section 72-2 while the radio communication apparatus 11 is connected to the other end of the wire circuit 22, information supplied from the network 1 is supplied to the radio communication apparatus 11 through the wire circuit 21, wire connection section 72-1, repeating section 71, wire connection section 72-2 and wire circuit 22. Meanwhile, information supplied from the radio communication apparatus 11 is supplied to the network 1 through the wire circuit 22, wire connection section 72-2, repeating section 71, wire connection section 72-1 and wire circuit 21.

Similarly, for example, where, as shown in FIG. 6, one end of the wire circuit 24 is connected to the wire connection section 72-3 while the radio communication apparatus 3 is connected to the other end of the wire circuit 24 (as indicated by a broken line) and one end of the wire circuit 22 is connected to the wire connection section 72-2 and the radio communication apparatus 11 is connected to the other end of the wire circuit 22, information supplied from the radio communication apparatus 3 is supplied to the radio communication apparatus 11 through the wire circuit 24, wire connection section 72-3, repeating section 71, wire connection section 72-2 and wire circuit 22. Meanwhile, information supplied from the radio communication apparatus 11 is supplied to the radio communication apparatus 3 through the wire circuit 22, wire connection section 72-2, repeating section 71, wire connection section 72-3 and wire circuit 24.

Where the radio communication apparatus 11 and the radio communication apparatus 3 are connected to each other physically (by a wire) through the information repeating apparatus 12 in this manner, such setting for radio communication between the radio communication apparatus 11 and the radio communication apparatus 3 as described above can be performed. It is to be noted, however, that, if, in this state, the network 1 is further connected to the information repeating apparatus 12 physically (by a wire), then the communication information described above may possibly flow also to the network 1. Accordingly, when the user tries to perform setting for radio communication, it should disconnect the wire circuit 21 from the wire connection section 72-1.

In this manner, the wire connection sections 72-1 to 72-3 interface with a radio communication apparatus (in the present case, a different wire communication apparatus connected to the network 1 or the radio communication apparatus 11 or the radio communication apparatus 3 which functions as a wire communication apparatus) similarly to the wire connection section 55 (FIG. 5). More particularly, since, for example, in the present case, the wire circuit 21, wire circuit 22 and wire circuit 24 are each formed from a LAN cable for the Ethernet (trademark), each of the wire connection sections 72-1 to 72-3 is formed as a port for connection of a terminal of a LAN cable for the Ethernet (trademark).

A power supply section 73 supplies electric power supplied thereto from an external power supply to a router function execution section 74. Further, the power supply section 73 supplies the electric power supplied thereto from the external power supply to the radio communication apparatus 11 through the repeating section 71 and the wire connection section 72-2 and further supplies the electric power to the radio communication apparatus 3 through the repeating section 71 and the wire connection section 72-3.

The information repeating apparatus 12 further includes a router function execution section 74 as occasion demands (where no router is connected to the network 1). The router function execution section 74 executes functions of a router.

The functions of a router include, for example, a function of analyzing a protocol of a network layer (third layer) or a transport layer (fourth layer) defined by the “OSI (Open Systems Interconnection) basic reference model” to perform transfer. More particularly, the functions of a router include, for example, a path selection function of checking an address of the network layer to discriminate which one of paths should be used for transfer. Also, for example, a function of abandoning all data other than data of a protocol or protocols for which the router itself is ready is included.

It is to be noted that the “OSI basic reference level” is a model wherein communication functions which a computer should have are divided into seven layers and a standard function module is defined for each layer based on the design policy “OSI” of a network structure for implementing data communication between different types prescribed by the ISO.

However, where some other router (not shown) is connected to the network 1, the router function execution section 74 is not a component essentially required by the information repeating apparatus 12.

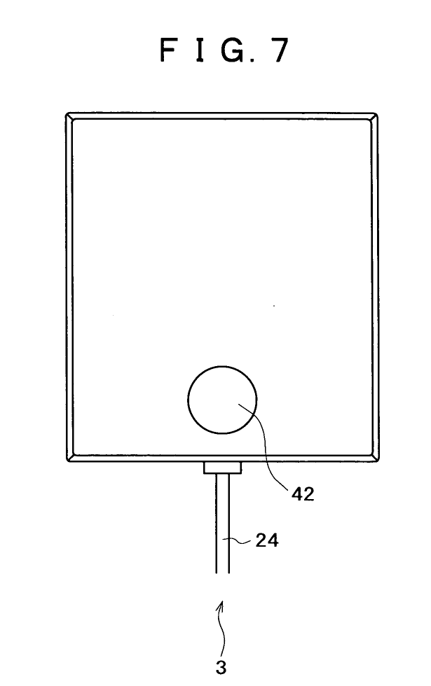

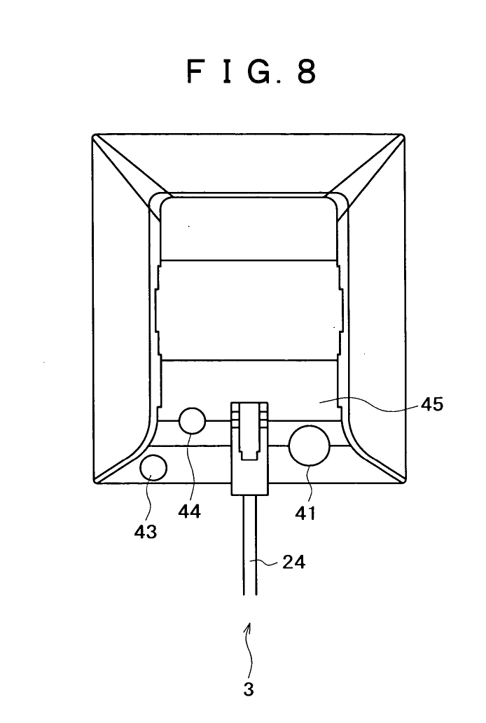

FIGS. 7 and 8 show an example of an appearance of the radio communication apparatus 3 connected to the information processing apparatus 4. As described hereinabove, the radio communication apparatus 3 may have a construction and functions similar to those of the radio communication apparatus 11. Therefore, FIGS. 7 and 8 which show an example of an appearance of the radio communication apparatus 3 are basically similar to FIGS. 3 and 4 which show an example of an appearance of the radio communication apparatus 11 described hereinabove. Therefore, further description of the radio communication apparatus 3 is not given with reference to FIGS. 7 and 8.

Similarly, FIG. 9 is a block diagram showing an example of an internal construction of the radio communication apparatus 3 connected to the information processing apparatus 4 and is a figure basically similar to FIG. 5 which shows an example of an internal setting of the radio communication apparatus 11. In particular, components of the radio communication apparatus 3 from a main control section 91 to an oscillation section 100 shown in FIG. 9 have a setting and functions basically similar to those of the components of the radio communication apparatus 11 from the main control section 51 to the oscillation section 60 shown in FIG. 5, respectively. Accordingly, further description of the components of the radio communication apparatus 3 is not given with reference to FIG. 9.

FIG. 10 shows an example of a construction of pieces of software for execution of setting radio communication by the radio communication apparatus 11 (access point side) and the radio communication apparatus 3. Each of the pieces of software is formed from a plurality of modules as seen in FIG. 10. Each module has an independent algorithm and executes unique operations in accordance with the algorithm. In particular, for example, the modules of the radio communication apparatus 11 are stored in the flash ROM not shown of the storage section 59 shown in FIG. 5 and are suitably read out (and developed in the SDRAM not shown of the storage section 99) and executed by the main control section 51. Similarly, for example, the modules of the radio communication apparatus 3 are stored in the flash ROM not shown of the storage section 99 shown in FIG. 9 and are suitably read out (and developed in the SDRAM not shown of the storage section 99) and executed by the main control section 91.

Paying attention to the radio communication apparatus 11 in FIG. 10, a communication information transmission standby state establishing module 121 changes the state of the radio communication apparatus 11.

In particular, the radio communication apparatus 11 is normally in a state wherein it can communicate with another radio communication apparatus by radio communication (such a state as just described is hereinafter referred to as normal state). If the setting switch 31 is depressed in the normal state, then it is necessary for the radio communication apparatus 11 to change the state thereof from the normal state to another state wherein the radio communication apparatus 11 allows execution of setting radio communication therewith. That is, a state wherein the radio communication apparatus 11 can transmit communication information (in the present case, an SSID and a WEP key) to a communication apparatus (in the present case, the radio communication apparatus 3) with which the radio communication apparatus 11 tries to execute radio communication (such a state as just described is hereinafter referred to as communication information transmission standby state).

Thus, if the communication information transmission standby state establishing module 121 detects, for example, that the setting switch 31 is depressed, then it changes the state of the radio communication apparatus 11 from the normal state to the communication information transmission standby state. On the other hand, if, for example, a communication information transmission module 124 hereinafter described detects that control for transmitting communication information is completed, then the communication information transmission standby state establishing module 121 changes the state of the radio communication apparatus 11 from the communication information transmission standby state to the normal state.

If it is detected that, for example, the setting switch 31 is kept depressed for more than a fixed period of time, then a communication information production module 122 produces communication information (in the present case, an SSID and a WEP key) necessary for radio communication and supplies the produced information to the communication information transmission module 124. Further, the communication information production module 122 uses the produced communication information to perform setting for radio communication for the radio communication apparatus 11 (access point 2) itself. The method for production of the communication information is not limited particularly, and, for example, where a WEP key of 128 bits is adopted, the communication information production module 122 can generate a random number and produce a WEP key of 128 bits and an SSID from the generated random number.

It is to be noted that, where it is presupposed that communication information is set in advance in the radio communication apparatus 11, the communication information production module 122 is not essentially required as a component of the radio communication apparatus 11. However, in the following description, it is assumed that communication information is produced by the communication information production module 122.

A communication information request reception module 123 controls the radio communication apparatus 11 to receive an information requesting packet (hereinafter referred to as communication information request) for requesting for communication information transmitted thereto from the radio communication apparatus 3 through a wire circuit. Then, if the communication information request reception module 123 confirms that it has received a communication information request normally by the radio communication apparatus 11 thereof, then it notifies the communication information transmission module 124 of the confirmation.

The communication information transmission module 124 controls, if it receives, from the communication information request reception module 123, a notification that a communication information request has been received, the radio communication apparatus 11 to transmit communication information (which may be in a form encrypted by an encryption module 125 as hereinafter described) produced in advance by the communication information production module 122 to the radio communication apparatus 3 through a wire circuit. Further, when the transmission control comes to an end, that is, when it is confirmed that the communication information has been transmitted normally from the radio communication apparatus 11, the communication information transmission module 124 notifies the communication information transmission standby state establishing module 121 of the normal transmission. Thus, the communication information transmission standby state establishing module 121 receives the notification and changes the state of the radio communication apparatus 11 from the communication information transmission standby state back to the normal state as described hereinabove.

The encryption module 125 encrypts communication information produced by the communication information production module 122 and supplied to the communication information transmission module 124. In particular, if communication information is supplied from the communication information transmission module 124 to the encryption module 125 before it is transmitted, then the encryption module 125 utilizes a predetermined encryption method to encrypt the communication information and supplies the encrypted communication information to the communication information transmission module 124. The communication information transmission module 124 controls the radio communication apparatus 11 to transmit the encrypted communication information to the radio communication apparatus 3.

Where the communication information is encrypted in this manner, the safety in communication can be further enhanced. In particular, in the present embodiment, setting for radio communication is performed between information communication apparatus of objects of the radio communication (in the present case, between the radio communication apparatus 11 and the radio communication apparatus 3) by wire communication. Accordingly, the safety is higher than where communication is performed by wire communication. However, two information communication apparatus of objects of setting for radio communication may not be connected directly to each other but be connected through a repeating apparatus such as a hub. In this instance, there is the possibility that the communication information may leak to another information communication apparatus connected to the repeating apparatus. In such an instance, if the communication information is in an encrypted form, then even if the communication information leaks to a different information processing apparatus, it is difficult for the different information processing apparatus to read or decrypt the communication information. In other words, even if the communication information leaks, if it is in an encrypted form, the contents can be protected.

It is to be noted that the encryption method is not limited particularly, and for example, the common key cryptography can be applied as the encryption method.

The common key cryptography is a cryptographic algorithm which has a property that a cryptographic key used for encryption of data and a cryptographic key used for decryption are the same as each other or, even where the two cryptographic keys are different from each other, it is easy to calculate one of the cryptographic keys from the other cryptographic key. As the common cryptography, for example, the DES (Data Encryption Standard) and the Triple DES adopted by the National Bureau of Standards in the U.S. Department of Commerce and the FEAL (Fast Data Encipherment Algorithm) developed by NTT (Nippon Telegraph and Telephone Corp. (trade name)) are known.

In particular, for example, the radio communication apparatus 3 first transmits a common key to the radio communication apparatus 11 by some method (for example, by including the common key in a communication information request).

The encryption module 125 uses the common key to encrypt the communication information, and the radio communication apparatus 11 supplies the encrypted communication information to the radio communication apparatus 3 by wire communication under the control of the communication information transmission module 124.

The radio communication apparatus 3 (a decryption module 135 hereinafter described) can use the common key sent formerly to the radio communication apparatus 11 to decipher the encrypted communication information to acquire the communication information.

It is to be noted that such a common key encryption method as described above is decided, for example, as a standardized method in the ISO/IEC (International Electro technical Commission) 9798-2 and is a technique which can be recognized readily by those skilled in the art, and therefore, detailed description of it is omitted herein.

Also it is possible to alternatively utilize, for example, the SSL (Secure Socket Layer) or the TLS (Transport Layer Security) as the encryption method.

The SSL or the TLS is a security technique which can prevent such threats as “wiretapping”, “falsification” or “spoofing” on a network.

It is to be noted that the SSL was developed by Netscap (trade name) and has been popularized as a cryptographic communication protocol on a network such as the Internet. The TLS was developed and standardized by the IETF (Internet Engineering Task Force), and the RFC (Request For Comments) 2246 is laid open. Accordingly, a great number of documents have been published on details of the SSL and the TLS, and the SSL and the TLS are techniques which can be recognized readily by those skilled in the art. Therefore, detailed description of them is omitted herein.

Now, notice is taken of the radio communication apparatus 3 connected to the information processing apparatus 4. A communication information reception standby state establishing module 131 changes the state of the radio communication apparatus 3.

In particular, when the radio communication apparatus 3 is in the normal state, if the setting switch 41 is depressed, then it is necessary for the radio communication apparatus 3 to change the state thereof from the normal state to another state wherein setting for radio communication is possible, that is, a state wherein the radio communication apparatus 3 can receive communication information (in the present case, an SSID and a WEP key) transmitted thereto from a radio communication apparatus (in the present case, the radio communication apparatus 11) with which the radio communication apparatus 3 tries to communicate (the state described is hereinafter referred to as communication information reception standby state).

Therefore, for example, if it is detected that the setting switch 41 is depressed, then the communication information reception standby state establishing module 131 changes the state of the radio communication apparatus 3 from the normal state to the communication information reception standby state and notifies a communication information request transmission module 132 of the change of the state.

Further, for example, if a communication information setting module 134 hereinafter described detects that setting for radio communication of the radio communication apparatus 3 itself has been performed (is completed), then the communication information reception standby state establishing module 131 changes the state of the radio communication apparatus 3 from the communication information reception standby state to the normal state.

If a notification that the state of the radio communication apparatus 3 has changed to the communication information reception standby state is received from the communication information reception standby state establishing module 131, that is, if the setting switch 41 is depressed, then the communication information request transmission module 132 produces a communication information request, that is, an information requesting packet for requesting for communication information to be acquired and controls the radio communication apparatus 3 to transmit the communication information request to the radio communication apparatus 11 by wire communication.

A communication information reception module 133 controls the radio communication apparatus 3 to receive communication information (in the present case, an SSID and a WEP key) transmitted thereto from the radio communication apparatus 11 by wire communication.

Further, if the communication information received by the radio communication apparatus 3 is in an encrypted form, then the communication information reception module 133 supplies the encrypted communication information to the decryption module 135. Then, when the communication information decrypted by the decryption module 135 is supplied to the communication information reception module 133, the communication information reception module 133 supplies the decrypted communication information to the communication information setting module 134.

On the other hand, if the communication information received by the radio communication apparatus 3 is not in an encrypted form, then the communication information reception module 133 supplies the communication information as it is to the communication information setting module 134.

If communication information is supplied from the communication information reception module 133 to the communication information setting module 134, then the communication information setting module 134 sets the communication information supplied thereto into the radio communication apparatus 3 itself.

Then, when the setting for radio communication is completed, the communication information setting module 134 notifies the communication information reception standby state establishing module 131 of the completion. The communication information reception standby state establishing module 131 receives the notification and changes the state of the radio communication apparatus 3 from the communication information reception standby state back into the normal state.

Subsequently, the setting process for radio communication in the information communication system of FIG. 1 to which the present invention is applied is described with reference to flow charts of FIGS. 11 and 12 and an arrow chart of FIG. 13. The flow chart of FIG. 11 illustrates an example of a setting process of the radio communication apparatus 11 of the access point 2 side while the flow chart of FIG. 12 illustrates an example of a setting process of the radio communication apparatus 3 connected to the information processing apparatus 4. FIG. 13 illustrates a relationship between the processes of the radio communication apparatus 11 and the radio communication apparatus 3.

While the setting processes of the radio communication apparatus 11 and the radio communication apparatus 3 are described individually in order with reference to FIGS. 11 and 12, the relationship between the processes of the radio communication apparatus 11 and the information repeating apparatus 12 can be recognized readily by referring to corresponding steps of FIG. 13.

It is assumed here that the radio communication apparatus 11 of the access point 2 side has produced communication information (in the present case, an SSID and a WEP key) and has the communication information set in the radio communication apparatus 11 itself already, and the initial states, that is, the states at present, of the radio communication apparatus 11 and the radio communication apparatus 3 are the normal states.

First, the setting process for ratio communication of the radio communication apparatus 11 of the access point 2 side is described with reference to FIGS. 11 and 13.

First at step S1, the communication information transmission standby state establishing module 121 of FIG. 10 discriminates whether or not the setting switch 31 is in an on state.

If it is discriminated at step S1 that the setting switch 31 is not in an on state, then the processing returns to step S1 to discriminate again whether or not the setting switch 31 is in an on state.

In other words, the communication information transmission standby state establishing module 121 constantly supervises the state of the setting switch 31, that is, whether the setting switch 31 is in an on state or in an off state.

If the setting switch 31 is depressed, then the communication information transmission standby state establishing module 121 discriminates at step S1 that the setting switch 31 is in on state. Thus, at step S2, the communication information transmission standby state establishing module 121 changes the state of the radio communication apparatus 11 from the normal state to the communication information transmission standby state.

In other words, the radio communication apparatus 11 is placed into a state wherein, when it receives a communication information request (information requesting packet) from a device physically connected (connected by a wire circuit) thereto (in the present case, the radio communication apparatus 3 connected thereto through the wire circuit 22, information repeating apparatus 12 and wire circuit 24 as seen in FIG. 2), it can transmit communication information.

It is to be noted that, at this point of time, the communication information transmission standby state establishing module 121 may cause the display section 58 (FIG. 5) to display such information from which it can be discriminated explicitly that the radio communication apparatus 11 is in the communication information transmission standby state.

Then at step S3, the communication information transmission standby state establishing module 121 starts counting of time. The method of the time counting is not limited particularly, and the communication information reception standby state establishing module 131 may count time, for example, based on a clock from the oscillation section 60 (FIG. 5) or may cause a timer not shown to start a counting operation and acquire the count value of the timer to perform time counting.

At step S4, the communication information transmission module 124 discriminates whether or not a communication information request is received.

As far as a notification of reception of a communication information request is received from the communication information request reception module 123, the communication information transmission module 124 discriminates that no communication information request is received. Thus, the communication information transmission module 124 discriminates at step S7 whether or not a predetermined period of time is counted.

If the communication information transmission module 124 discriminates at step S4 that no communication information request is received, then it detects the period of time counted by the communication information transmission standby state establishing module 121, that is, the period of time after the point of time at which the time counting is started by the process at step S3 till the point of time. Then, the communication information transmission module 124 discriminates whether or not the detected period of time exceeds a predetermined threshold value to discriminate whether or not the predetermined period of time is counted.

If it is discriminated at step S7 that the predetermined period of time is counted (when time-out occurs), the communication information transmission standby state establishing module 121 ends the time counting and executes a predetermined error process at step S8 and then ends the setting process for radio communication.

In short, if a communication information request is not received within a fixed period of time after the setting switch 31 is depressed, then the radio communication apparatus 11 determines that the setting for radio communication has been canceled or some trouble has occurred, and executes an error process.

It is to be noted that, at this time, the communication information transmission standby state establishing module 121 may return the state of the radio communication apparatus 11 to the normal state or may newly set a different state that differs from the normal state or the communication information transmission standby state and change the state of the radio communication apparatus 11 to the newly set state.

Further, the error process at step S8 is not essentially required but may be executed or not executed. In other words, the object of the process at step S8 is to change the state of the radio communication apparatus 11 from the communication information transmission standby state to any other state such as the normal state.

On the other hand, if it is discriminated at step S7 that the fixed period of time is not counted as yet, then the processing returns to step S4, at which it is discriminated whether or not a communication information request is received. In other words, the communication information transmission module 124 constantly supervises that a communication information request is received after the state of the radio communication apparatus 11 is changed to the communication information transmission standby state.

In a normal case, if the setting switch 31 is placed into an on state (depressed), then also the radio communication apparatus 3 is connected to the information repeating apparatus 12 through the wire circuit 24 within a fixed period of time (or before a fixed period of time), that is, the state illustrated in FIG. 2 is established and also the setting switch 41 of the radio communication apparatus 3 side is depressed as hereinafter described.

Consequently, also the radio communication apparatus 3 changes its state to the communication information reception standby state, produces a communication information request and transmits the produced communication information request to the radio communication apparatus 11 through the wire circuit 24, information repeating apparatus 12 and wire circuit 22 (steps S21 to S24 of FIGS. 12 and 13).

The communication information request reception module 123 controls reception of the communication information request and issues, when it confirms that the communication information request is received normally, a notification of the reception to the communication information transmission module 124.

After the communication information transmission module 124 receives the notification from the communication information request reception module 123 that the communication information request is received normally, it discriminates at step S4 that a communication information request is received. Then at step S5, the communication information transmission module 124 controls the radio communication apparatus 11 to transmit communication information produced in advance by the communication information production module 122 (in the present case, an SSID and a WEP key) to the radio communication apparatus 3 through the wire circuit 22, information repeating apparatus 12 and wire circuit 24 (refer to FIG. 2).

It is to be noted that, where it is necessary to encrypt the communication information, at this point of time, that is, at the point of time of step S5, the encryption module 125 encrypts the communication information to be transmitted and the communication information transmission module 124 controls transmission of the encrypted communication information.

Then, if the communication information transmission module 124 confirms that the communication information has been transmitted normally, then it notifies the communication information transmission standby state establishing module 121 of the normal transmission.

The communication information transmission standby state establishing module 121 receives the notification and ends the time counting and then changes the state of the radio communication apparatus 11 into the normal state at step S6. The setting process of radio communication for the radio communication apparatus 11 of the access point 2 side is ended thereby.

It is to be noted that, while, in the example of FIG. 11, the state of the radio communication apparatus 11 is changed to the normal state at a point of time when communication information is transmitted, the timing of the changing to the normal state is not limited to that of the example of FIG. 11, but may alternatively be a point of time at which, for example, new information such as acknowledge information is received from the radio communication apparatus 3.

Now, the setting process for radio communication of the radio communication apparatus 3 connected to the information processing apparatus 4 corresponding to the setting process for radio communication of the radio communication apparatus 11 of the access point 2 side described above is described with reference to FIGS. 12 and 13.

At step S21, the communication information reception standby state establishing module 131 of FIG. 10 discriminates whether or not the setting switch 41 is in an on state.

If it is discriminated at step S21 that the setting switch 41 is not in an on state, then the processing returns to step S21 to discriminate again whether or not the setting switch 41 is in an on state.

In other words, the communication information reception standby state establishing module 131 constantly supervises the state of the setting switch 41, that is, whether the setting switch 41 is in an on state or in an off state.

If the setting switch 41 is depressed, then the communication information reception standby state establishing module 131 discriminates at step S21 that the setting switch 41 is in an on state. Then at step S22, the communication information reception standby state establishing module 131 changes the state of the radio communication apparatus 3 from the normal state to the communication information reception standby state.

In particular, the radio communication apparatus 3 is placed into a state wherein it can transmit a communication information request (information requesting packet) to a device physically connected (connected by a wire circuit) thereto (in the present case, the radio communication apparatus 11 connected thereto through the wire circuit 24, information repeating apparatus 12 and wire circuit 22 as seen in FIG. 2) and then receive communication information (in the present case, an SSID and a WEP key) transmitted thereto in response to the request.

It is to be noted that, at this point of time, the communication information reception standby state establishing module 131 may cause the display section 98 (FIG. 9) to display information from which it can be discriminated explicitly that the radio communication apparatus 3 is in the communication information reception standby state.

Then at step S23, the communication information reception standby state establishing module 131 starts counting of time. The method of the timing counting is not limited particularly, and the communication information reception standby state establishing module 131 may perform the time counting, for example, based on a clock from the oscillation section 100 (FIG. 9) or cause a timer not shown to start a time counting operation and acquire the count value of the timer to perform the time counting similarly to the radio communication apparatus 11 (communication information transmission standby state establishing module 121) of the access point 2 side.

Then, the communication information reception standby state establishing module 131 notifies the communication information request transmission module 132 that the state of the radio communication apparatus 3 has been changed to the communication information reception standby state.

Upon reception of the notification, the communication information request transmission module 132 produces a communication information request and controls the radio communication apparatus 3 to transmit the communication information request to the radio communication apparatus 11 by wire communication at step S24.

It is to be noted that the destination of the communication information request may be the access point 2 (radio communication apparatus 11) or may alternatively be broadcast destinations.

At step S25, the communication information reception module 133 discriminates whether or not communication information is received successfully.

As far as communication information is not supplied to the communication information reception module 133, it discriminates at step S25 that communication information is not received successfully and then discriminates at step S28 whether or not a predetermined period of time is counted.

If the communication information reception module 133 discriminates at step S25 that communication information is not received successfully, then it detects, at step S28, the period of time counted by the communication information reception standby state establishing module 131, that is, the period of time after the point of time at which the counting is started by the process at step S23 till the point of time then thereby to discriminate whether or not a fixed period of time is counted.

If it is discriminated at step S28 that the fixed period of time is counted (that is, if time-out occurs), then the communication information reception standby state establishing module 131 ends the time counting and executes a predetermined error process at step S29 and then ends the setting process for radio communication.

In short, if communication information is not received within a fixed period of time after the setting switch 41 is depressed, then the radio communication apparatus 3 determines that the setting for radio communication is canceled or some trouble has occurred and thus executes the error process.

It is to be noted that, at this time, the communication information reception standby state establishing module 131 may return the state of the radio communication apparatus 3 to the normal state or otherwise may newly set a state different from the normal state or the communication information reception standby state and change the state of the radio communication apparatus 3 to the newly set state.

Further, the error process at step S29 is not essentially required, but the error process may be executed or may not be executed. In other words, the object of the process at step S29 is to change the state of the radio communication apparatus 3 from the communication information reception standby state to any other state such as the normal state.

On the other hand, if it is discriminated at step S28 that the fixed period of time is not counted as yet, then the processing returns to step S24, at which the communication information request is transmitted again. It is to be noted that, at step S24 in this instance, a new communication information request may be produced and transmitted or the communication information produced by the process at step S24 in the preceding cycle may be transmitted again.

In particular, a communication information request is periodically and continually transmitted from the radio communication apparatus 3 until after a fixed period of time elapses or communication information is received as seen in FIG. 13. Consequently, the radio communication apparatus 3 can supply a communication information request to the radio communication apparatus 11 with certainty as long as the radio communication apparatus 11 remains in the communication information transmission standby state.

In a normal case, if the setting switch 41 is placed into an on state (depressed), then also the setting switch 31 of the radio communication apparatus 11 side is depressed within a fixed period of time and the state of the radio communication apparatus 11 is changed to the communication information transmission standby state by the process at step S2 as described hereinabove. Then, when the communication information request transmitted from the radio communication apparatus 3 is received by the radio communication apparatus 11 through the wire circuit 24, information repeating apparatus 12 and wire circuit 22 (refer to FIG. 2), that is, when it is discriminated by the process at step S4 that a communication information request is received, then communication information (in the present case, an SSID and a WEP key) is transmitted from the radio communication apparatus 11 by the process at step S5.

The communication information transmitted from the radio communication apparatus 11 is transmitted to the radio communication apparatus 3 through the wire circuit 22, information repeating apparatus 12 and wire circuit 24 (refer to FIG. 2). Therefore, the communication information reception module 133 controls reception of the communication information, and when it confirms that the communication information is received normally, it discriminates that the communication information is received successfully and supplies the communication information to the communication information setting module 134 at step S25.

It is to be noted that, where the communication information is in an encrypted form, at this point of time, the communication information reception module 133 supplies the encrypted communication information to the decryption module 135. Then, when decrypted communication information is received from the decryption module 135, the communication information reception module 133 supplies the decrypted communication information to the communication information setting module 134.

Consequently, the communication information setting module 134 sets, at step S26, the received communication information (in the present case, an SSID and a WEP key) in the radio communication apparatus 3 itself and notifies, when the setting is completed, the communication information reception standby state establishing module 131 of the completion of the setting.

Upon reception of the notification, the communication information reception standby state establishing module 131 ends the time counting and changes the state of the radio communication apparatus 3 to the normal state at step S27. The setting process for radio communication of the radio communication apparatus 3 is ended thereby.

After the setting process for radio communication of the radio communication apparatus 3 and the radio communication apparatus 11 is ended in such a manner as described above, the radio communication apparatus 3 and the radio communication apparatus 11 can perform mutual radio communication therebetween.

Accordingly, if the user disconnects one end of the wire circuit 24 from the information repeating apparatus 12 and connects the disconnected end of the wire circuit 24 to the information processing apparatus 4 (to establish the state illustrated in FIG. 1), then the information processing apparatus 4 can communicate with a different information processing apparatus (not shown) connected to the network 1 through the radio communication apparatus 3, access point 2 (radio communication apparatus 11 and radio repeating apparatus 12) and network 1 as described hereinabove.

In this manner, in the information communication system of the present embodiment, the access point 2 (radio communication apparatus 11) in which communication information necessary for communication through a radio network is set in advance and the radio communication apparatus 3 are connected to each other by a wire (connected through the wire circuit 24 (as well as the information repeating apparatus 12 and wire circuit 22)). Further, if a predetermined signal based on an operation of the user is inputted to the access point 2 (radio communication apparatus 11) and the radio communication apparatus 3 (that is, the setting switch 31 and the setting switch 41 of FIG. 2 are depressed), then the access point 2 (radio communication apparatus 11) transmits the communication information to the radio communication apparatus 3 through the wire circuit, and the radio communication apparatus 3 sets the communication information in the radio communication apparatus 3 itself.

Accordingly, in the present embodiment, a personal computer is not required for setting for radio communication (the necessity to use a setting tool installed in a personal computer is eliminated), and information necessary for setting for radio communication is exchanged in response to a predetermined trigger while manual registration of an apparatus is not performed. Consequently, it is possible to set setting information (the communication information described above and this includes identification information such as, for example, an SSID and information regarding the security such as a WEP key) in a station (for example the radio communication apparatus 3 of FIG. 1) by a simple operation of the user. In other words, the first and second subjects of the conventional apparatus described hereinabove can be solved.

Furthermore, in the present embodiment, each of the access point and the station performs independent time management and performs discrimination of an error in setting for radio communication based on the time management.

In particular, in the information communication system of the present embodiment shown in FIG. 2, when the access point 2 (radio communication apparatus 11) to which communication information necessary for radio communication through a radio communication network is set in advance receives a communication information request from the radio communication apparatus 3 through the wire circuit 24 (and the information repeating apparatus 12 and wire circuit 22) within a period of time before a predetermined first period of time elapses after setting for performing communication with the radio communication apparatus 3 through the radio network is started, that is, within a period of time after the setting switch 31 is depressed, it transmits the communication information to the radio communication apparatus 3 by wire transmission. On the other hand, when the radio communication apparatus 3 receives communication information of an object of the request issued to the access point 2 (radio communication apparatus 11) by wire communication within a period of time until after a predetermined second period of time elapses after setting for performing communication with the access point 2 (radio communication apparatus 11) is started through a radio network, that is, within a period of time after the setting switch 41 of FIG. 9 is depressed, it sets the received communication information in the radio communication apparatus 3 itself.

Where attention is paid to the access point 2 (radio communication apparatus 11), the access point 2 (radio communication apparatus 11) is connected to the radio communication apparatus 3 through a wire (the wire circuit 24 (and the information repeating apparatus 12 and wire circuit 22)), and when it receives a request for transmission of communication information necessary for communication through a network from the radio communication apparatus 3, that is, when it receives a communication information request, before a predetermined period of time elapses after the access point 2 (radio communication apparatus 11) starts setting for performing radio communication with the radio communication apparatus 3 through a radio network, the access point 2 (radio communication apparatus 11) transmits the communication information set in advance in the access point 2 (radio communication apparatus 11) itself to the radio communication apparatus 3 by wire transmission.

Where attention is paid to the radio communication apparatus 3, it is connected to the access point 2 (radio communication apparatus 11) through the wire circuit 24 (and the information repeating apparatus 12 and wire circuit 22), and after setting for performing radio communication with the access point 2 (radio communication apparatus 11) through a radio network is started, that is, when the setting switch 41 is depressed, the radio communication apparatus 3 transmits request information for requesting for communication information necessary for radio communication through a radio network to the access point 2 (radio communication apparatus 11). Then, if communication information corresponding to the request information is transmitted from the access point 2 (radio communication apparatus 11) to the radio communication apparatus 3 through a wire line before a predetermined period of time elapses after the setting is started, the radio communication apparatus 3 receives the communication information and sets it into the radio communication apparatus 3 itself.

More particularly, if the access point 2 (radio communication apparatus 11) starts a setting process for radio communication earlier, then it enters and remains in the communication information transmission standby state for a fixed period of time. Then, if the access point 2 (radio communication apparatus 11) does not receive a communication information request from the station (radio communication apparatus 3) in the meantime, then time-out occurs and the access point 2 (radio communication apparatus 11) enters the normal state (or a predetermined state different from the communication information transmission standby state or the normal state). On the other hand, if the station (radio communication apparatus 3) starts a setting process for radio communication earlier, then it enters and remains in the communication information reception transmission state for a fixed period of time. Then, if the station (radio communication apparatus 3) does not receive communication information from the access point 2 (radio communication apparatus 11) in the meantime, time-out occurs and the station (radio communication apparatus 3) enters the normal state (or a predetermined state different from the communication information transmission standby state or the normal state).

Accordingly, the timings of the triggers for setting radio communication of the access point 2 (radio communication apparatus 11) and the station (radio communication apparatus 3), that is, in the present case, the timings at which the setting switch 31 and the setting switch 41 are depressed, do not matter. As a result, the user can provide a trigger to each of the access point 2 (radio communication apparatus 11) and the station (radio communication apparatus 3) in accordance with the taste of the user itself.

Also the timing at which the station (radio communication apparatus 3) is connected to the access point 2 (radio communication apparatus 11) by a wire, that is, the timing at which electric power is supplied to the station (radio communication apparatus 3), need not particularly be the beginning, but the station (radio communication apparatus 3) may be connected to the access point 2 (radio communication apparatus 11) by a wire to start setting the station (radio communication apparatus 11), that is, in the present case, the setting switch 41 may be depressed, before time-out occurs with the access point 2 (radio communication apparatus 11) after setting of the access point 2 (radio communication apparatus 11) is started, that is, in the present case, after the setting switch 31 is depressed, or in other words, within a fixed period of time after the setting switch 31 is depressed.

In this manner, in the present embodiment, since each of the access point 2 (radio communication apparatus 11) and the station (radio communication apparatus 3) performs independent time management, the flexibility in operation of the user is improved, that is, the operation of the user is simplified. Consequently, the first and second subjects described hereinabove can be solved.

Further, in the present embodiment, since each of the access point 2 (radio communication apparatus 11) and the station (radio communication apparatus 3) performs independent time management, that is, since the setting for mutual radio communication is started at a timing before time-out occurs with one of them, it is difficult for any other access point than the access point 2, with whom the user wants to communicate, that is, for an access point managed by any other than the user or the like, to estimate a timing for starting of setting for radio communication. In other words, it is difficult for an access point other than the access point 2, with which the user wants to communicate, to perform setting for radio communication with the station (radio communication apparatus 3) possessed by the user, and consequently, the safety in radio communication can be anticipated. In other words, even if a plurality of access points are involved, the user can perform radio communication only with the access point 2 with which the user wants to communicate. Accordingly, the third and fourth subjects described hereinabove can be solved.

Incidentally, the information communication system to which the present invention is applied is not limited to the form shown in FIG. 1 but may have various forms.

For example, the setting process for radio communication is not limited to the process described hereinabove with reference to FIGS. 11 to 13, but may be such a process as described below. In particular, referring to FIG. 2, the user will first depress the setting switch 41 of the radio communication apparatus 3 as a station to connect the radio communication apparatus 3 and the information repeating apparatus 12 to each other through the wire circuit 24, that is, to connect the radio communication apparatus 3 and the radio communication apparatus 11 of the access point 2 side physically by a wire. Consequently, the radio communication apparatus 3 enters the communication information reception standby state. Then, before time-out occurs with the radio communication apparatus 3, the user will depress the setting switch 31 of the radio communication apparatus 11. Consequently, also the radio communication apparatus 11 enters the communication information transmission standby state. The succeeding processes of the radio communication apparatus 3 and the radio communication apparatus 11 are basically similar to those described hereinabove with reference to FIGS. 11 to 13.

By applying such a setting process as just described, where two or more radio communication apparatus 11 are connected to the information repeating apparatus 12, or in other words, where a plurality of access points are involved, the user can set the radio communication between an access point (the radio communication apparatus 11) with which the user wants to communicate and a station with a higher degree of certainty.

Further, for example, in FIG. 1, the apparatus which performs radio communication with the access point 2 (radio communication apparatus 11), that is, the station, is the radio communication apparatus 3 connected to the different information processing apparatus 4, or in other words, substantially the different information processing apparatus 4 performs communication. However, the station may be an independent apparatus.

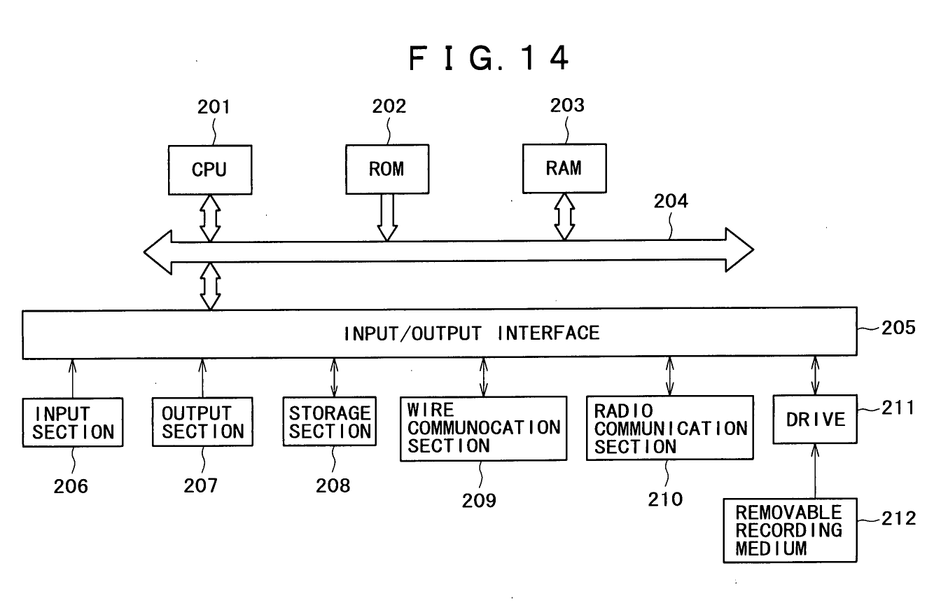

In this instance, naturally the radio communication apparatus 3 may perform radio communication with the access point 2 (radio communication apparatus 11) independently, that is, without being connected to another apparatus. However, for example, such a personal computer as shown in FIG. 14 may be utilized as an apparatus which performs radio communication with the access point 2 (radio communication apparatus 11).

Referring to FIG. 14, a central processing unit (CPU) 201 executes various processes in accordance with a program stored in a read only memory (ROM) 202 or a program loaded from a storage section 208 into a random access memory (RAM) 203.

In particular, for example, a program composed of the modules described hereinabove with reference to FIG. 10 from the communication information reception standby state establishing module 131 to the decryption module 135 is stored in the ROM 202, the storage section 208 or the like, and the CPU 201 suitably reads out and executes the modules.

Also data and so forth necessary for the CPU 201 to execute various processes are suitably stored into the RAM 203.

The CPU 201, ROM 202 and RAM 203 are connected to each other by a bus 204. Also an input/output interface 205 is connected to the bus 204.

An input section 206 including a keyboard, a mouse and so forth, an output section 207 including a display unit and so forth, a storage section 208 formed from a hard disk and so forth, a wire communication section 209 and a radio communication section 210 are connected to the input/output interface 205.

Thus, the radio communication section 210 controls radio communication, for example, with the radio communication apparatus 11 of the access point 2.

Further, in such a setting process for radio communication which is controlled by the radio communication section 210 as described above, the personal computer of FIG. 14 is connected in place of the radio communication apparatus 3 of FIG. 2 to the information repeating apparatus 12 by the wire circuit 24. In particular, the personal computer of FIG. 14 and the radio communication apparatus 11 are connected to each other physically by a wire through the wire circuit 24, information repeating apparatus 12 and wire circuit 22.

In this instance, the wire communication section 209 performs control of transmitting a communication information request described hereinabove to the radio communication apparatus 11 through the wire circuit 24, information repeating apparatus 12 and wire circuit 22. Further, the wire communication section 209 performs control of receiving communication information described hereinabove transmitted from the radio communication apparatus 11 through the wire circuit 22 information repeating apparatus 12 and wire circuit 24.

A trigger signal for starting a setting process for radio communication may be inputted from a switch in the form of hardware such as the setting switch 31 or the setting switch 41 described hereinabove (in the present case, such a switch as just described is provided as a component of the input section 206). However, the trigger signal may otherwise be inputted from a software switch.

As occasion demands, a drive 211 is connected to the input/output interface 205, and a removable recording medium 212 which may be a magnetic disk, an optical disk, a magneto-optical disk or a semiconductor memory is suitably loaded into the drive 211 and a computer program such as, for example, a program as illustrated in FIG. 10 read out from the removable recording medium 212 is installed into the storage section 208.

Also the radio communication apparatus 11 of the access point 2 side is not limited to the apparatus described hereinabove with reference to FIGS. 3 to 5, but, for example, the personal computer of FIG. 14 may be utilized.

In this instance, for example, a program composed of the modules described hereinabove with reference to FIG. 10 from the communication information transmission standby state establishing module 121 to the encryption module 125 is stored in the ROM 202, the storage section 208 or the like, and the CPU 201 suitably reads out and executes the modules.

Further, the radio communication section 210 controls radio communication, for example, with the radio communication apparatus 3 or some other personal computer or the like.

Further, where the radio communication section 210 described above functions as a radio communication section of the access point 2, the personal computer of FIG. 14 is connected in place of the radio communication apparatus 11 of FIG. 2 to the information repeating apparatus 12 through the wire circuit 22. In particular, where such setting of radio communication as described above is performed, the personal computer of FIG. 14 and the radio communication apparatus 3 or some other personal computer are connected to each other physically by a wire through the wire circuit 22, information repeating apparatus 12 and wire circuit 24.

In this instance, the wire communication section 209 performs control of receiving a communication information request described hereinabove transmitted from the radio communication apparatus 3 or some other personal computer through the wire circuit 24, information repeating apparatus 12 and wire circuit 22. Further, the wire communication section 209 performs control of transmitting communication information above-described to the radio communication apparatus 3 or some other personal computer through the wire circuit 22 information repeating apparatus 12 and wire circuit 24.

Further, where such a personal computer as described above does not include, for example, the radio communication section 210, if it includes, for example, a PC card connection section 221 connected to the input/output interface 205 as shown in FIG. 15, then it can perform radio communication readily by connecting or attaching a radio LAN PC card 222 to the PC card connection section 221.

In other words, it is possible to recognize that, in FIG. 1, the information processing apparatus 4 is the personal computer having the construction of FIG. 15 and the radio communication apparatus 3 connected to the information processing apparatus 4 is the radio LAN PC card 222.

Further, it is not essentially required for the radio communication apparatus 11 to function as an access point of the external network 1, but in the present embodiment, it is only necessary that the radio communication apparatus 11 and the radio communication apparatus 3 can perform mutual radio communication therebetween. In particular, while, in the example described hereinabove, the radio communication apparatus 11 is used in a form wherein it is connected to an external network through an access point, that is, in a form of the infrastructure mode, it is also possible to alternatively apply an Ad-Hoc mode wherein radio communication apparatus perform radio communication therebetween. In this instance, one of the radio communication apparatus 11, radio communication apparatus 3 and the personal computer having the construction of FIG. 14 or 15 serves as a master apparatus while the other apparatus serve as slave apparatus. Accordingly, each of the master and slave apparatus can execute the series of processes described hereinabove to perform setting the radio communication.

It is to be noted that the master apparatus here is an apparatus which merely outputs a beacon first, and if the output of the beacon from the master apparatus is interrupted by some reason, then the slave apparatus begins to output a beacon after a period of a random number and now serves as a new master apparatus. Further, if the master apparatus detects a beam outputted from any other apparatus, it discriminates based on the time stamp of the beacon whether the master apparatus or the other apparatus outputting the detected beacon should take precedence, and depending upon the discrimination, the master apparatus may be replaced by the other apparatus.

Furthermore, the communication method of the information communication system to which the present invention is applied is not limited to a radio LAN, and any other radio communication system such as, for example, the Bluetooth or some wire communication system may be used as the communication method of the information communication system.

Incidentally, in order for the modules described hereinabove with reference to FIG. 10 to execute predetermined functions, a program which constructs the software for the functions is installed from a network or a recording medium.

The recording medium may be formed as a package medium (removable recording medium 212) such as, for example, as shown in FIG. 14 or 15, a magnetic disk (including a floppy disk), an optical disk (including a CD-ROM (Compact Disk-Read Only Memory) and a DVD (Digital Versatile Disk)), a magneto-optical disk (including an MD (Mini-Disk)), or a semiconductor memory which has the program recorded thereon or therein and is distributed in order to provide the program to a user separately from the body of an apparatus, or as a ROM 202 or a hard disk included in the storage section 208 which has the program stored therein or thereon and is provided to a user in a form wherein it is incorporated in the body of an apparatus. Or, the recording medium may be formed as the storage section 59 of FIG. 5 or the storage section 99 of FIG. 9.

Further, the modules shown in FIG. 10 may have any form only if they achieve their respective functions.

In particular, the modules may be formed, for example, from hardware elements. In this instance, a manufacturer or the like can implement a block for performing setting for radio communication of a radio communication apparatus on the access point side having a setting different that of FIG. 5, 14 or 15 readily, for example, by fabricating hardware elements corresponding to the components of FIG. 10 from the communication information transmission standby state establishing module 121 to the encryption module 125 and connecting them as seen in FIG. 10. Further, the manufacturer or the like can implement a block for performing setting for radio communication of a radio communication apparatus on the station side having a setting different from that of FIG. 9, 14 or 15 readily, for example, by fabricating hardware elements corresponding to the components of FIG. 10 from the communication information reception standby state establishing module 131 to the decryption module 135 and connecting them as seen in FIG. 10.

Also the construction of, for example, the program is not limited to that of the example of FIG. 10, but may have a module construction which includes modules each of which includes a combination of some or all of the functions of some of the modules shown in FIG. 10 or includes modules obtained by dividing the modules shown in FIG. 10. Alternatively, the program may merely have a single algorithm.

It is to be noted that, in the present specification, the steps which describe the program recorded in or on a recording medium may be but need not necessarily be processed in a time series in the order as described, and include processes which are executed parallelly or individually without being processed in a time series.

Further, in the present specification, the term “system” is used to represent an entire apparatus composed of a plurality of apparatus or processing sections.

While a preferred embodiment of the present invention has been described using specific terms, such description is for illustrative purposes only, and it is to be understood that changes and variations may be made without departing from the spirit or scope of the following claims.

What is claimed is:

1. An information communication system, comprising:
two or more information communication apparatuses connected to each other by a network and including first and second information communication apparatuses;
said first information communication apparatus having communication information necessary for communication through said network set therein in advance;
said first information communication apparatus being connected to said second information communication apparatus by a wire circuit;
said first and second information apparatuses being operable, when a predetermined signal based on an operation of a user is inputted individually to said first and second information apparatuses, such that said first information communication apparatus transmits the communication information to said second information communication apparatus through said wire circuit and said second information communication apparatus sets the communication information transmitted thereto from said first information communication apparatus, whereafter said first and second information communication apparatus utilize the communication information set therein to perform communication therebetween.

2. An information communication method for an information communication system wherein two or more information communication apparatuses including first and second information communication apparatus are connected to each other by a network, said first information communication apparatus having communication information necessary for communication through said network set therein in advance, said first information communication apparatus being connected to said second information communication apparatus by a wire circuit, said information communication method being performed when a predetermined signal based on an operation of a user is inputted individually to said first and second information apparatuses, said information communication method comprising:
a step performed by said first information communication apparatus of transmitting the communication information to said second information communication apparatus through said wire circuit;
another step performed by said second information communication apparatus of setting the communication information transmitted thereto from said first information communication apparatus; and
a further step performed by said first and second information communication apparatus of utilizing the communication information set therein to perform communication therebetween.

3. An information communication apparatus which communicates with a different information communication apparatus connected to a network through said network, comprising:
connection means for establishing a connection to said different information communication apparatus through a wire circuit;
input means for inputting a trigger signal to start setting necessary for said information communication apparatus to communicate with said different information communication apparatus through said network; and
transmission control means for controlling, when a request for transmission of communication information necessary for communication through said network is received from said different information communication apparatus connected to said connection means through said wire circuit after the trigger signal is inputted from said input means, transmission of the communication information set in advance in said information communication apparatus to said different information communication apparatus through said connection means and said wire circuit.

4. An information communication apparatus according to claim 3, wherein said network is a radio network.

5. An information communication apparatus according to claim 3, wherein said input means is a button of hardware.

6. An information communication apparatus according to claim 3, wherein the communication information includes at least one of identification information of said network and information regarding the security.

7. An information communication apparatus according to claim 6, wherein the identification information of said network is a Service Set Identification.

8. An information communication apparatus according to claim 6, wherein the information regarding the security is a Wired Equivalent Privacy key.

9. An information communication apparatus according to claim 3, further comprising encryption means for encrypting the communication information at least once, said transmission control means controlling the transmission of the communication information encrypted by said encryption means.

10. An information communication method for an information communication apparatus which communicates with a different information communication apparatus connected to a network through said network, comprising:
a transmission control step of controlling, when a request for transmission of communication information necessary for communication through said network is received from said different information communication apparatus connected to said information communication apparatus through a wire circuit after a trigger signal for starting setting necessary for performing communication with said different information communication apparatus through said network is inputted, transmission of the communication information set in advance in said information communication apparatus to said different information communication apparatus through said wire circuit.

11. A program for causing a computer, which controls an information communication apparatus which communicates with a different information communication apparatus connected to a network through said network, to execute:
a transmission control step of controlling, when a request for transmission of communication information necessary for communication through said network is received from said different information communication apparatus connected to said information communication apparatus through a wire circuit after a trigger signal for starting setting necessary for performing communication with said different information communication apparatus through said network is inputted, transmission of the communication information set in advance in said information communication apparatus to said different information communication apparatus through said wire circuit.

12. An information communication apparatus which communicates with a different information communication apparatus connected to a network through said network, comprising:
connection means for establishing a connection to said different information communication apparatus through a wire circuit;
input means for inputting a trigger signal to start setting necessary for said information communication apparatus to communicate with said different information communication apparatus through said network;
transmission control means for controlling, after the trigger signal is inputted from said input means, transmission of request information for requesting for communication information necessary for communication through said network to said different information communication apparatus through said connection means and said wire circuit;
reception control means for controlling, when the communication information is transmitted from said different information apparatus to said information communication apparatus through said wire circuit in response to the request information transmitted under the control of said transmission control means, reception of the communication information through said connection means; and
setting means for setting the communication information received under the control of said reception control means.

13. An information communication apparatus according to claim 12, wherein said network is a radio network.

14. An information communication apparatus according to claim 13, further comprising conversion means for converting a signal transmitted through said radio network to said information communication apparatus into a signal which can be transmitted by said wire circuit and converting a signal transmitted through said wire circuit into a signal which can be transmitted in said radio network.

15. An information communication apparatus according to claim 13, wherein said information communication apparatus is a personal computer card for a radio local area network.

16. An information communication apparatus according to claim 12, wherein said input means is a button of hardware.

17. An information communication apparatus according to claim 12, wherein the communication information includes at least one of identification information of said network and information regarding the security.

18. An information communication apparatus according to claim 17, wherein the identification information of said network is a Service Set Identification.

19. An information communication apparatus according to claim 17, wherein the information regarding the security is a Wired Equivalent Privacy key.

20. An information communication apparatus according to claim 12, wherein the communication information received under the control of said reception control means is encrypted at least once, said information communication apparatus further comprising decryption means for decrypting the encrypted communication information received under the control of said reception control means, said setting means setting the communication information decrypted by said decryption means.

21. An information communication method for an information communication apparatus which communicates with a different information communication apparatus connected to a network through said network, comprising:
a transmission control step of controlling, after the trigger signal for starting setting necessary to communicate with said different information communication apparatus through said network is inputted to said information communication apparatus, transmission of request information for requesting for communication information necessary for communication through said network to said different information communication apparatus through said wire circuit;
a reception control step of controlling, when the communication information is transmitted from said different information apparatus to said information communication apparatus through said wire circuit in response to the request information transmitted under the control of the process at the transmission control step, reception of the communication information by said information communication apparatus; and
a setting step of setting the communication information received under the control of the process at the reception control step to said information communication apparatus.

22. A program for causing a computer, which controls an information communication apparatus which communicates with a different information communication apparatus connected to a network through said network, to execute:
a transmission control step of controlling, after the trigger signal for starting setting necessary to communicate with said different information communication apparatus through said network is inputted to said information communication apparatus, transmission of request information for requesting for communication information necessary for communication through said network to said different information communication apparatus through said wire circuit;
a reception control step of controlling, when the communication information is transmitted from said different information apparatus to said information communication apparatus through said wire circuit in response to the request information transmitted under the control of the process at the transmission control step, reception of the communication information by said information communication apparatus; and
a setting step of setting the communication information received under the control of the process at the reception control step to said information communication apparatus.

23. An information communication system, comprising:
two or more information communication apparatuses connected to each other by a network and including first and second information communication apparatus;
said first information communication apparatus having communication information necessary for communication through said network set therein in advance;
said first information communication apparatus transmitting, when a request for transmission of the communication information is received from said second information communication apparatus through a wire circuit before a predetermined first period of time elapses after said first information communication apparatus starts setting for performing communication with said second information communication apparatus through said network, the communication information to said second information communication apparatus through said wire circuit;
said second information communication apparatus setting, when the communication information for which said second information communication apparatus has requested to said first information communication apparatus through said wire circuit is transmitted to said second information communication apparatus from said first information communication apparatus through said wire circuit before a predetermined second period of time elapses after setting for performing communication with said first information communication apparatus through said network is started, the communication information transmitted thereto from said first information communication apparatus;
said first and second communication apparatus thereafter utilizing the communication information set therein to perform communication therebetween.

24. An information communication method for an information communication system wherein two or more information communication apparatuses including first and second information communication apparatus are connected to each other by a network and said first information communication apparatus has communication information necessary for communication through said network set therein in advance, comprising:
a step performed by said first information communication apparatus of transmitting, when a request for transmission of the communication information is received from said second information communication apparatus through a wire circuit before a predetermined first period of time elapses after said first information communication apparatus starts setting for performing communication with said second information communication apparatus through said network, the communication information to said second information communication apparatus through said wire circuit;
another step performed by said second information communication apparatus of setting, when the communication information for which said second information communication apparatus has requested to said first information communication apparatus through said wire circuit is transmitted to said second information communication apparatus from said first information communication apparatus through said wire circuit before a predetermined second period of time elapses after setting for performing communication with said first information communication apparatus through said network is started, the communication information transmitted thereto from said first information communication apparatus; and
a further step performed by said first and second communication apparatus of utilizing the communication information set therein to perform communication therebetween.

25. An information communication apparatus which communicates with a different information communication apparatus connected to a network through said network, comprising:
connection means for establishing a connection to said different information communication apparatus through a wire circuit; and
transmission control means for controlling, when a request for transmission of communication information necessary for communication through said network is received from said different information communication apparatus connected to said connection means through said wire circuit before a predetermined period of time elapses after setting for performing communication with said different information communication apparatus through said network is started, transmission of the communication information set in advance in said information communication apparatus to said different information communication apparatus through said connection means and said wire circuit.

26. An information communication method for an information communication apparatus which communicates with a different information communication apparatus connected to a network through said network, comprising:
a transmission control step of controlling, when a request for transmission of communication information necessary for communication through said network is received from said different information communication apparatus connected to said information communication apparatus through said wire circuit before a predetermined period of time elapses after setting for performing communication with said different information communication apparatus through said network is started, transmission of the communication information set in advance in said information communication apparatus to said different information communication apparatus through said wire circuit.

27. A program for causing a computer, which controls an information communication apparatus which communicates with a different information communication apparatus connected to a network through said network, to execute:
a transmission control step of controlling, when a request for transmission of communication information necessary for communication through said network is received from said different information communication apparatus connected to said information communication apparatus through said wire circuit before a predetermined period of time elapses after setting for performing communication with said different information communication apparatus through said network is started, transmission of the communication information set in advance in said information communication apparatus to said different information communication apparatus through said wire circuit.

28. An information communication apparatus which communicates with a different information communication apparatus connected to a network through said network, comprising:
connection means for establishing a connection to said different information communication apparatus through a wire circuit;
transmission control means for controlling, when setting for performing communication with said different information communication apparatus through said network is started, transmission of request information for requesting for communication information necessary for communication through said network to said different information communication apparatus through said connection means and said wire circuit;
reception control means for controlling, when the communication information is transmitted from said different information communication apparatus to said information communication apparatus through said wire circuit in response to the request information transmitted under the control of said transmission control means, reception of the communication information through said connection means; and
setting means for setting the communication information to said information communication apparatus when the reception of the communication information by said reception control means comes to an end before a predetermined period of time elapses after the setting is started.

29. An information communication method for an information communication apparatus which communicates with a different information communication apparatus connected to a network through said network, comprising:
a transmission control step of controlling, when setting for performing communication with said different information communication apparatus through said network is started by said information communication apparatus, transmission of request information for requesting for communication information necessary for communication through said network to said different information communication apparatus through said wire circuit;
a reception control step of controlling, when the communication information is transmitted from said different information communication apparatus to said information communication apparatus through said wire circuit in response to the request information transmitted under the control of the process at the transmission control step, reception of the communication information by said information communication apparatus; and
a setting step of setting the communication information to said information communication apparatus when the reception of the communication information by the process at the reception control step comes to an end before a predetermined period of time elapses after the setting is started.

30. A program for causing a computer, which controls an information communication apparatus which communicates with a different information communication apparatus connected to a network through said network, to execute:
a transmission control step of controlling, when setting for performing communication with said different information communication apparatus through said network is started by said information communication apparatus, transmission of request information for requesting for communication information necessary for communication through said network to said different information communication apparatus through said wire circuit;
a reception control step of controlling, when the communication information is transmitted from said different information communication apparatus to said information communication apparatus through said wire circuit in response to the request information transmitted under the control of the process at the transmission control step, reception of the communication information by said information communication apparatus; and
a setting step of setting the communication information to said information communication apparatus when the reception of the communication information by the process at the reception control step comes to an end before a predetermined period of time elapses after the setting is started.
